(19) United States
(12) Patent Application Publication
(10) Pub. No.: US 2011/0038012 A1
(43) Pub. Date: Feb. 17, 2011

(54) METHOD AND DEVICE AGAINST FORGERY

(75) Inventors: Jean-Pierre Massicot, Rueil Malmaison (FR); Alain Foucou, Rueil Malmaison (FR); Zbigniew Sagan, Rueil Malmaison (FR)

Correspondence Address: YOUNG & THOMPSON, 209 Madison Street, Suite 500, Alexandria, VA, 22314, US

(73) Assignee: ADVANCED TRACK & TRACE, RUEIL MALMAISON (FR)

(21) Appl. No.: 12/519,256

(22) PCT Filed: Dec. 14, 2007
(86) PCT No.: PCT/FR07/02085

§ 371 Date: Nov. 18, 2009

(30) Foreign Application Priority Data
Dec. 14, 2006 (FR) 0610891
Dec. 26, 2006 (FR) 0611402
Jun. 1, 2007 (FR) 0703922
Jun. 22, 2007 (FR) 0704517

(51) Int. Cl. H04N 1/40

(52) U.S. Cl. 358/3.28; 382/100

(57) ABSTRACT

The method includes determining characteristics of an item of equipment printing the original document; determining a mark allowing an original to be distinguished from a copy, according to characteristics of the print equipment destined to be utilized for printing the mark on the document; printing the mark with the print equipment to form the original document; and determining a first limit value to be used by an item of copy detection equipment to distinguish the original document from a copy of the original document, according to at least one print of the mark. Preferably, the method includes a step of printing at least one print reference representative of an authorized maximum or minimum inking for printing the document and, during the step of determining the first limit value, a measurement is determined over at least one the print reference and a tolerance is added to it.

This invention concerns a method and a device for fighting against counterfeiting. It concerns, in particular, the production and exploitation of digital authentication codes (“DAC”). Among these digital authentication codes, this invention applies in particular to copy detection patterns (“CDP”), secured information matrices (“SIM”), arranged dot patterns and/or digital watermarks, to the secured and robust production, tracking and authentication of manufactured items and products, packaging, etc.

Counterfeiting and forging certificates, bank notes, electronic money elements, passports, attestations, checks, diplomas, revenue stamps, or other items has existed almost as long as these documents. On the other hand, while the problems of counterfeiting and “grey” or black markets of industrial products have existed for a long time, they have grown to a considerable extent over recent years. Today, significant proportions of industrial products are either counterfeits or have been misappropriated from their authorized markets by their distributers. The holders of intellectual property rights are relatively powerless to deal with this problem: laws are ill-adapted or unequal in different geographical areas, and it is difficult to find the source of or track, i.e. reproduce the path of, counterfeit or misappropriated products.

The holders of these intellectual property rights wish above all to measure the extent of the problem or problems they are confronted with: are they faced with counterfeiting or grey market problems, or a combination of both, in which markets, etc? Also, the owners of intellectual property rights, in particular trademarks, models and designs, and the organizations that generate official documents and that have adopted encrypted two-dimensional (“2D”) bar codes or other data carriers, such as RFID (acronym for “Radio Frequency Identification”) electronic tags, to help them solve their forgery problems, must nevertheless use radically different authentication methods (“authenticators”), such as holograms, security inks, microtexts, or so-called “guilloche” patterns (fine curved lines interfering with digital reproduction systems, for example through a watermark effect), to avoid or detect slavish counterfeiting.

Nevertheless these means have their limits, which become more and more apparent with the rapid distribution of technology, allowing counterfeiters to make better and better copies of these authenticators in less and less time. Thus, holograms are copied better and better by the counterfeiters and the end-users have neither the capabilities nor the motivation to check these holograms. Security inks, so-called “guilloche” patterns and microtexts are difficult to insert into companies' production lines or information channels and do not offer the level of security generally required. Moreover, they can be difficult to identify and do not offer real guarantees of security against determined counterfeiters.

The difficulty of integrating these authentication means is also a factor limiting their use, especially in cases where production is decentralized. Thus a multinational often has production sites in several countries, often using several sub-contractors. The logistics for shipping physical security elements (security ink, DNA marker, etc) to each of these production sites is very difficult and, at the very least, very costly. Poor stock management or a shipping delay can mean production is suspended or unprotected.

DACs offer an interesting alternative to traditional methods of securing documents. In the “all-digital” age they offer an essentially digital solution that has all the functionalities required, i.e. traceability of products, automatic authentication (detection of copies), detection of forgeries. They dematerialize the procedure for producing secure documents: a trademark is inserted by modifying a digital file of a document, or by adding an image that is an authenticator (i.e. that allows copies to be detected automatically) and, possibly, an identifier, to it. Reading is done by automatically processing a digital image capture of a document; the reader may possibly be connected to a secured database.

DACs are especially interesting for the holders of rights on manufactured products that have particularly stringent cost and production requirements: in effect DAC image files can be ordered, sent and received instantaneously.

Another advantage of the DACs is the possibility of using standard image capture devices, such as mass-market scanners or digital cameras, possibly integrated in digital personal assistants (or mobile telephones), to verify the DACs. These make the large-scale deployment of DACs possible, given the low cost and ease with which such capture devices can be obtained. In contrast, a security ink requires a dedicated reader, often costly, and obliges the rights holder to commit to a solution that is vulnerable and costly to implement, with the consequences and risks this entails.

Among the DACs, SIMs and CDPs are specific digital authentication codes. Other DACs include digital watermarks and arranged dot patterns, if these have authentication properties. Digital authentication codes, DACs, present the potential, at least in theory, of tracking each document or product individually.

Like 2D bar codes secured information matrices, SIMs, are representations of matrix information on a surface, which can be read by a machine from an image capture. But unlike 2D bar codes (which are in two dimensions), SIMs are not simply “containers” of information: they are designed so as to ensure the security of the documents on which they are printed. In particular they enable many problems to be dealt with concerning the counterfeiting (identical copies, reproductions) or forging (expiry date for a medicine, identity card, etc) of documents, and ensure their traceability, notably making the fight against the grey market possible. Of course, some of these problems can be partially dealt with by ordinary 2D bar codes, such as Datamatrix (registered trademark), through the addition of a cryptographic layer protecting the writing and reading of messages. However, SIMs offer much more extensive handling of the problems relating to security. For example, SIMs make it possible to detect cases of counterfeiting via true copy or photocopy, which in theory is not possible with the other types of information matrices. In particular, any copy of an original printed SIM can be detected. In effect, as described in documents PCT FR 2007/000918 and PCT FR 2007/001246, included here as reference, the error rate for decoding the message carried by the copied SIM is greater than the maximum tolerated error rate for an original printed SIM. Moreover, SIMs offer the possibility of using different read or write permission levels, each locked by a cryptographic key, each permission level corresponding to a security layer: if a cryptographic key is compromised only the corresponding security layer is affected.

Thanks to their relatively large capacity in terms of quantity of information and the possibility of using different levels of read and write permissions, SIMs enable all the values related to the document's traceability to be stored in a secure way, such as, for example, a unique identity number, an expiry date, a manufacturing order, a provenance, a destination market, etc. It is advantageous for each SIM to be unique, i.e. one SIM carrying a specific message can only be printed once: we then talk of “serialized” printing. In this way, it is ensured that each of the existing documents can be uniquely identified. SIMs are generally used in this way for digital types of printing methods, i.e. in which a processor communicates directly with the print means and can vary the contents printed, in particular with digital, laser, ink-jet print means allowing the serialized printing of SIMs.

Copy detection patterns, CDPs, are a type of visible authentication patterns, which generally appear to be noise and are generated from a key in a pseudo-random way. These copy detection patterns, CDPs, are basically used to distinguish original printed documents and printed documents copied from the former, for example by photocopying or using a scanner and a printer. This technique operates by comparing a captured image of an analog, i.e. real-world, copy detection pattern with an original digital representation of this pattern to measure the degree of difference between the two of them. The underlying principle is that the degree of difference is higher for the captured image of a pattern that has not been produced from an original analog pattern, as a result of degradation during copying. To carry information, the CDP's image is divided into areas and each area can contain different configurations of pixel values (all appearing to be noise), each configuration being associated to a binary value.

Their operating principle during reading can often be equated to the energy level measurement of a signal in the captured image, subsequently known as the “score”, which is compared against a threshold value, generally pre-defined: if the score is greater than this threshold value, it is deduced that the image is an original. If not, it is deduced that it is a copy. There can also be a “grey” area of indecision in the area around the threshold value, where the decision is not clear-cut, and if the score is located in this area a new image capture is requested.

For the SIMs the score can be, for example, measured as a decreasing function of the captured SIM's error rate. For the CDPs it can be measured as the index of similarity between the original CDP and the captured CDP. For the digital watermarks the score can be measured by the degree of correlation between the original watermark, i.e. the signal before its modulation in the marked image, and the captured image, once the image has been filtered in the suitable frequency spectrum and the signals have been synchronized. Finally, for the arranged dot patterns, the score can be measured by the value at the peak of cross-correlation between the original dot pattern and the dot pattern in the captured image. It is noted that numerous other measurements are possible, and in particular that the distance measurements can be inverted to represent measurements of closeness or similarity.

The value of the threshold (or possibly the thresholds if the “grey” area of indecision described above is used) is generally pre-calculated by making use of the statistical distribution of the scores for a sample representative of all the original DAC prints. Techniques known in prior art are used for estimating the average, variance or standard deviation, and the theoretical probabilities (one could, for example, consider that an original is much more probable than a copy) are sometimes used. Cost factors can be assigned to the detection system's error types, in which case a threshold value that minimizes this risk is defined. For example, in some applications it is considered more acceptable for an original to be wrongly detected as a copy than the opposite, since, for a “copy” decision, a second reading that will confirm or dispel the doubts can be performed.

It is noted that the DACs can be invisible or at least difficult to see, for example a digital watermark vulnerable to copying integrated in the image, or a pseudo-randomly arranged dot pattern, also known as an “AMSM”. The pseudo-randomly distributed dots present a certain density, low enough to be difficult to locate, for example with a density of 1%. A score relating to the peak of cross-correlation between the reference AMSM and the captured AMSM corresponds to the signal's energy level, and theoretically it will be lower for the copies.

While the DACs have many advantages, implementing a traceability system based on the DACs nevertheless poses many problems that are currently unresolved, whether concerning their integration in these documents or their use in fighting against counterfeiting.

With regard to the threshold value calculation, one problem arises from the fact that the statistical distribution of the copies' scores is an abstraction. It can be decided to “ignore it”, in which case the threshold value can be set by considering the error rate acceptable if only originals are read. Thus, for a threshold value equal to the average less three standard deviations (s=m−3*e), assuming a Gaussian distribution of the scores, the probability that an original is detected as a copy is 0.44%. There are many possible methods for knowing the probability of a copy being detected as an original: for example, from an image of an original, it can be seek to make the best copy possible using the same print procedure for the copy as for the original, estimate the statistical distribution of the copy's scores, and then estimating the probability that a copy has a score that is greater than the threshold value can be performed. It can also be made the assumption that a similar rate of degradation is applied when an original is printed and a copy is printed: thus, if for the originals the score is 20% less than the score in the case where the image has not been degraded at all, the assumption that the score of an original print will also undergo a loss of 20% during copying can be made, in which case a copy should have on average 66% of the maximum score. Other similar approaches are possible, and the printing of an original and a copy can also be modeled, by digital spatial filtering, (for example, adding noise and low-pass Gaussian filtering).

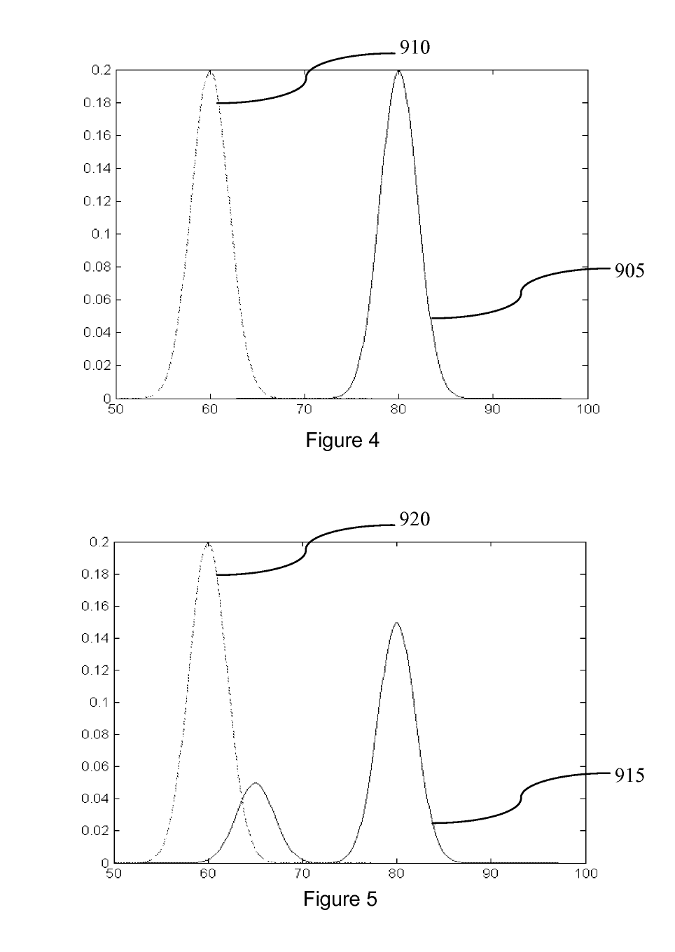

It is seen that determining the threshold value and the reliability of the system (whether measured by average error rates, cost, or other aspects) is highly dependent on the statistical distribution of the originals' scores, which must, ideally, have as small a standard deviation as possible. In practice, print distortions in production can cause a dispersion of the originals' scores such that the system's reliability is greatly reduced. As an example, FIGS. 4 and 5 show two distributions 905 and 915 of scores for the original prints and two hypothetical distributions 910 and 920 for the copies (in effect, as has been said, properly speaking there is no universal distribution of the copies' scores), when the production of original documents is properly controlled, as shown in FIG. 4, and when it is poorly controlled, as shown in FIG. 5. In the first case, the distribution 905 of the originals' scores follows a Gaussian distribution, and the separation from the copies' scores 910 is clear: all the original prints have been carried out in identical conditions. In contrast, in the second case the distribution of the originals' scores 915 is more widespread and the ability to completely separate the originals' scores 915 and copies' scores 920 is no longer certain, the area (a) shown by an arrow corresponding to values of scores where relying on the result from the detector cannot be made. The spread of the distribution of the originals' scores corresponds to a combination of the distributions illustrated in FIGS. 4 and 5 with respective proportions of ¾ and ¼: these distributions correspond to production conditions that may be in part different. It can be imagined, for example, that the first three-quarters of the production were carried out with constant ink density conditions, then, following a change of operator, the new operator did not respect the initial ink density conditions, which has caused a reduction in the DAC's score.

There are also several unresolved problems with regard to using DACs, especially the robustness of the reading, the security and availability of read modules, and the interoperability of security systems.

In the preceding discussion on the score, the implicit assumption was made that there was only one single possible score for a print of a DAC: that would indeed be the case if the image capture was “perfect” or, at least, identical each time. However, the capture and quality of the image can vary from one capture tool to the next, and even from one capture to the next using the same capture tool. And the quality of the image capture can have a considerable impact on the score.

The image capture tool's internal parameters can also have an impact. For example, the image quality, and therefore the score, of a DAC captured with a scanner can vary according to the image capture resolution, number of bits per pixel, etc. In addition, an image capture device can realize poor image captures. For example, if an object containing a DAC is poorly positioned on a scanner, the captured image may be blurred. If a portable tool is used and if the operator does not take care, the image can have a sharpness problem due to a movement or positioning the DAC outside the focal plane. Typically, the DAC's score can be noticeably lower and an original can therefore be detected as a copy.

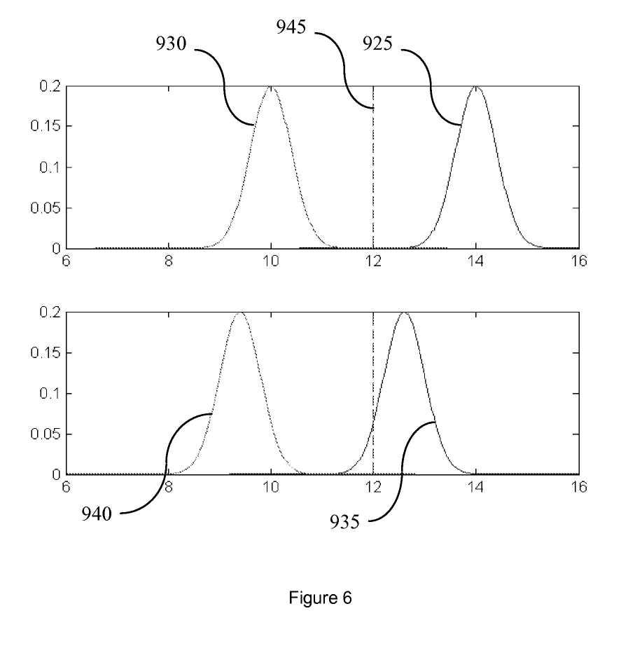

There can therefore be, on the one hand, problems of poor image capture quality with a tool that can otherwise realize image captures of the required quality. On the other hand, there can be intrinsic quality differences between the image capture tools, especially the image capture tool used to initially calculate the statistical distribution of the scores and the image capture tool used in operation/reading, which can be expressed by a shift of the score. If this is not taken into account, each threshold value calculated initially can induce numerous errors in determining authenticity. FIG. 6 shows, in the upper portion, a statistical distribution of scores for the originals, 925, and the copies, 930, calculated based on images taken with a reference image capture tool, a calculated threshold value minimizing the average error rate for this distribution. In the lower portion, this figure shows the statistical distribution of scores for the same originals, 935, and copies, 940, based on images captured by another, lower quality, image capture tool. The threshold value, as calculated for the reference image capture tool, is indicated on it, at 945. It can clearly be seen that the threshold value used is not adequate and may lead to numerous detection errors. It is noted that the score represented in FIG. 6 is divided by five with respect to the score represented in FIGS. 4 and 5. For example, the limit value, which has a value of 12 in FIG. 6, corresponds to a score of 60 in FIGS. 4 and 5.

Concerning security with regard to the availability of read modules, the DAC verification tools can operate either locally or linked to a server. In the first case, the danger is that a counterfeiter gets hold of a module and carries out “reverse engineering” in order to determine the read algorithms used, to deduce the corresponding generation algorithms from these (the read algorithms are generally symmetrical with the DAC generation algorithms) and above all get hold of cryptographic keys stored in the module.

Another problem concerns the fact that the dedicated read modules are not always available, either for security reasons, or because there is a limited number of them, or because they are too expensive.

With regard to the interoperability of systems based on DACs, nothing is currently specified. However inspectors authorized by associations of rights owners may authenticate and track the products to the various points of sale. Likewise, customs officers may be provided with readers to check the DACs on the various products entering a country or a geographic area that has a free-trade agreement. Nevertheless the rights owners are generally very concerned about the confidentiality of their data and they clearly do not want other rights owners, possibly competitors, to be able to access their information. For example, in their eyes it would be catastrophic if a competitor could check their DACs and from this deduce information about their distribution methods or, even worse, notice that fake products were included in their distribution. Here, the rights owners' interests do not necessarily match the general interest, which is for a maximum of people to be informed if counterfeits are present in the distribution channels.

Each of the aspects of the present invention aims to remedy all or part of the inconveniences described above.

This invention thus aims, according to its various aspects, to remedy the difficulties of integrating and/or using DACs, in particular the problems of security, stability and lack of flexibility in integrating DACs for the production of secure documents and/or the problems of security, stability and lack of flexibility in using DACs for the verification of secure documents.

Certain aspects of this invention aim to remedy these inconveniences.

To this end, according to a first aspect, the present invention envisages a method for reading a digital authentication code, characterized in that it comprises:
a step of capturing an image representative of a digital authentication code,
a step of determining capture conditions for said image,
a step of determining an error rate for said digital authentication code represented by said captured image and
a step of determining the authenticity of the digital authentication code according to the error rate and the capture conditions for said image.

Thanks to these provisions, it is possible, in order to determine a document's authenticity, to utilize different image capture means, different means of lighting the DAC, or process an image which is partially blurred or is not of a sufficiently good quality. The reading and authentication procedure is thus much more robust than the procedures known in prior art.

According to particular features, the step of determining capture conditions for said image comprises a step of determining a value representative of the quality of said image's capture.

According to particular features, the step of determining an image's capture conditions comprises a step of determining a value representative of the blurring of said image's capture.

According to particular features, during the step of determining the authenticity, first of all it is determined whether the value representative of the blurring represents blurring below a pre-defined value and, if it is, whether the error rate is below a pre-defined value.

According to particular features, if the value representative of blurring represents blurring above a pre-defined value the method returns to the steps of capturing an image, of determining the error rate and of determining authenticity are repeated.

Thus, a warning occurs when the blurring does not enable a sufficiently reliable determination of authenticity and the procedure's steps can be repeated.

According to particular features, if the value representative of the blurring represents blurring below a pre-defined value, at least one part of said image is transmitted to a remote server and the step of determining authenticity is carried out by said remote server.

More complex processing can therefore be carried out by a system having more resources in terms of processing capacity.

According to particular features, during the step of determining, first of all it is determined whether the error rate is below a pre-defined value and, if not, whether value representative of the blurring represents blurring below a pre-defined value.

According to particular features, the step of determining a value representative of the blurring utilizes values representative of the digital authentication code's print conditions.

In this way the reliability of the procedure is increased since the digital authentication code's print quality, which could have an impact on the value representative of the blurring, is taken into account.

According to particular features, the method that is the subject of the present invention, as described in brief above, comprises, after the step of capturing an image and before the step of determining authenticity, a step of detecting the presence of a digital authentication code in said image, the steps of determination only being carried out if there is a digital authentication code in said image and the step of capturing an image being repeated if the digital authentication code is absent from said image.

Thanks to these provisions, the procedure can be applied to a series of captured images, without the user needing to initiate the capture of an image.

According to particular features, during the step of detecting the presence of a digital authentication code, it is determined whether the image represents a geometric shape characteristic of said codes.

For example, a square or rectangular shape is automatically searched for.

According to particular features, during the step of determining a value representative of blurring, a value is determined that is representative of a gradient in a digital authentication code.

In this way, the blurring represented by this gradient is easily determined, especially when the blurring comes from a faulty positioning of the digital authentication code with respect to the sharpness plane conjugated with the capture plane by the lens of the image capture means.

According to particular features, during the step of determining a value representative of blurring, a Sobel filter is utilized.

According to particular features, during the step of determining a value representative of blurring, a Gaussian filter is utilized.

According to particular features, the method that is the subject of the present invention, as described in brief above, comprises:
a step of capturing an image representative of a test chart,
a step of determining an adjustment value from the image representative of the test chart and
a step of adjusting the error rate according to said adjustment value, the step of determining the authenticity of the digital authentication code utilizing the adjusted error rate.

Thanks to these provisions, image-taking faults are automatically taken into account and these are measured very accurately because the test chart is, inherently, standardized.

According to particular features, during the step of capturing an image representative of a test chart, an image of a card is captured, the method that is the subject of the present invention, as described in brief above, comprising a step of reading, on said card, an identifier of the card carrier and a step of verifying said carrier's authorization to carry out a step of determining authenticity.

In this way a non-authorized user who does not have the card can be prohibited from utilizing the method that is the subject of the present invention.

According to particular features, the step of determining an image's capture conditions comprises a step of determining the number of dots of said image that correspond to a digital authentication code.

In this way, the resolution of the digital authentication code's image, which has a big impact on the error rate, can be taken into account.

According to particular features, the step of determining the number of dots of said image that correspond to a digital authentication code comprises a step of determining the resolution of the image capture device as the number of dots per unit of surface area placed in its sharpness plane.

According to particular features, during the step of determining an image's capture conditions the print sharpness of the digital authentication code is determined.

According to particular features, said sharpness is determined by reading, in the digital authentication code's content, a type of printing used to print said digital authentication code.

According to particular features, the method that is the subject of the present invention, as described in brief above, comprises:
a step of sending the captured image to a secure remote server, by means of a computer network, the step of determining an error rate and the step of determining the authenticity of the digital authentication code being carried out by said remote server and
a step of returning a message from the secure server indicating whether the digital authentication code is authentic, a copy or whether a new image must be captured.

According to a second aspect, the present invention envisages a device for reading a digital authentication code, characterized in that it comprises:
a means of capturing an image representative of a digital authentication code,
a means of determining said image's capture conditions,
a means of determining an error rate for said digital authentication code represented by said captured image and
a means of determining the authenticity of the digital authentication code according to the error rate and the capture conditions for said image.

As the particular characteristics, advantages and aims of this device, this computer program and this data carrier are similar to those of the method that is the subject of this invention, as described in brief above, they are not repeated here.

Concerning the integration of DACs in the production of secure documents, the unresolved problems include in particular the security of digital files and the stability of the marking. With regard to the security of digital files, when a DAC is printed or marked on a product it is, in theory, almost impossible to copy with a sufficiently high quality so as to confuse the copy and the original. On the other hand, initially a DAC is generally presented in the form of an image file, which allows an unlimited number of authentic DACs to be produced. It therefore appears essential to protect this file throughout its life. However, such a digital image file can pass through several hands, be integrated in a product design or prepress file, etc. Often rights holders are obliged to entrust this file to the processor, for example a printer, over whom they have little control. Moreover, for many marking processes, such as offset, the image file is not printed directly but passes through at least one analog transformation step, for example when the plate is created and sometimes when the film is created that is used to make the plate, etc. These plates or films must also be protected since they allow authentic DACs to be generated. Lastly, there is no means of control ensuring that the processor, authorized by the rights holder to produce a given number of documents, has not produced a surplus quantity that they will sell to an unauthorized third party.

With regard to the stability of the marking, DACs require an especially stable print process in order to work properly. In effect, the operating principle can often be equated to the energy level measurement of a signal in the captured image, subsequently known as the “score”, this score generally being higher for the original documents than the copies (distance measurements in which, as a general rule, the distance will be less for the original documents than for the copies can also be used). It is essential for this score to be as “stable” as possible for the original prints. In effect, the greater the statistical distribution of the scores of the original prints, the less this score makes it possible to differentiate effectively between the originals and the copies. Yet, in practice, the means of marking comprise numerous adjustment parameters that are dependent, for example, on the product to be marked, the substrate or the inking, and which can significantly affect the DAC's score. For the same production run, these parameters can also change over time, be adjusted differently by different operators, etc. Without complete control over the means of producing documents, the ability to detect copies can be significantly reduced.

With regard to the flexibility of integration in the existing procedures, when a DAC is integrated into a document, secure (and traceable or allowing audits) data exchanges must generally take place between several parties. Typically, these parties can be the rights owner (for example, a pharmaceutical company who wishes to produce medicines protected against copying), the processor or processors (for example, the printer of a package and/or a label), and the DAC provider, who is often a third-party. If the information exchange processes are not automated, how can you ensure that the DACs with suitable values will be correctly printed on the corresponding documents or products? This is a critical problem for large-scale applications where the rights owner must protect hundreds, even thousands, of different types of products, and work with sub-contractors located in different countries or continents. In effect, the integration errors risk being so numerous that they can make the system unusable, or significantly reduce its credibility. As an example of an integration error, take the case of a sub-contractor, having to handle the insertion of several DACs into several products, who inserts a DAC into a document that does not correspond to it.

Certain aspects of this invention aim to remedy these inconveniences.

To this end, according to a third aspect, the present invention envisages a method for checking the print quality, characterized in that it comprises:
a step of printing a digital authentication code carrier, utilizing print parameter values,
a step of capturing an image of the digital authentication code printed on said carrier,
a step of determining a print quality of the digital authentication code according to the image of the digital authentication code and
a step of printing at least one other carrier with print parameters according to said print quality

Thanks to these provisions, the print quality is checked by processing an image of the digital authentication code and the printing of carrier(s) only continues if the image quality is sufficiently high.

According to particular features, during the step of determining the print quality, the print quality is determined according to an information content of the digital authentication code read in said image. For example, the information content identifies a carrier type (for example paper or cardboard, colors, glazing, etc).

According to particular features, during the step of determining the print quality, an error rate is determined in the digital authentication code read in said image, the image quality being a function of said error rate.

Thanks to these provisions, the quality measurement can be standardized. It is noted that, during subsequent processing of the carrier, the digital authentication code can be separated from the useful part, this digital authentication code thus being used solely to determine the carrier's print quality.

According to particular features, the method that is the subject of the present invention, as described in brief above, comprises a step of determining if said image both allows a value borne by the printed digital authentication code to be read and presents an error rate less than a pre-defined limit value.
if this is not the case, a step of producing a new carrier and a repetition of the step of reading and the step of determining and
if this is the case, a step of printing digital authentication codes utilizing said carrier's print parameters.

According to particular features, the method that is the subject of the present invention, as described in brief above, comprises a step of determining said pre-defined limit value according to the value represented by the digital authentication code.

According to particular features, the method that is the subject of the present invention, as described in brief above, comprises:
a step of printing a plurality of digital authentication codes, utilizing print parameter values,
a step of capturing images of a plurality of printed digital authentication codes,
a step of determining the print quality for each one of a plurality of said images and
a step of storing a value representative of said print quality.

Thanks to these provisions, the initial print quality can be taken into account when subsequently determining whether a carrier is an original or a copy, which makes the method that is the subject of the present invention more reliable and easier to make operational.

According to particular features, said step of determining the image quality comprises the determination of an error rate for each one of a plurality of said images and, during the step of storing, an error rate limit value is stored, according to said determined error rates.

For example, the operator is asked for a minimum of readings, for example 30, taken in a uniform way during the production, so as to determine the error rate statistics, or “score” for the production.

According to particular features, the method that is the subject of the present invention, as described in brief above, comprises, performed by a server that supplies digital authentication codes:
a step of transmitting digital authentication codes, in a secure way, to printing systems for integrating in the document's design,
a step of receiving quality measurements of digital authentication codes printed on documents,
a step of determining whether the production is valid based on measurements received and
a step of transmitting a message indicating whether the production is valid.

According to particular features, during the step of transmitting digital authentication codes, the server transmits, first of all, at least one control file allowing a digital authentication code to be printed that cannot be used, because of its information content, for authenticating a carrier production and, if the production is valid, the server transmits at least one other digital authentication code representative of information linked to said production.

According to particular features, the method that is the subject of the present invention, as described in brief above, comprises:
a step of printing a pre-defined number of documents bearing a said digital authentication code,
a step of capturing an image of each digital authentication code printed and
a step of storing an item of information representative of each digital authentication code printed.

According to particular features, the method that is the subject of the present invention, as described in brief above, comprises a step of determining a signature of each captured image of a digital authentication code, and a step of storing said signature in a database, with the information relating to the production run.

In this way, by using the signature, it is possible to subsequently retrieve, for each document printed, whether its production had been authorized and also the related information enabling its traceability.

According to particular features, the method that is the subject of the present invention, as described in brief above, comprises a step of printing an information matrix representing said signature on the document bearing the DAC corresponding to said signature.

According to particular features, the method that is the subject of the present invention, as described in brief above, comprises:
a step of capturing images of a part of the printed digital authentication codes and determining, by utilizing analysis parameter values, a rating representative of the print quality of said digital authentication code and
a step of presenting said rating representative of the print quality to the operator.

According to particular features, said analysis parameter values are representative of a print error rate of the digital authentication codes and by which, during the step of determining a rating, said rating is representative of a difference between the error rate represented by the analysis parameter values and the error rate determined from said image.

According to particular features, the method that is the subject of the present invention, as described in brief above, comprises a step of determining an average error rate from at least one digital authentication code image and, from a pre-defined instance, during the step of determining a rating, said rating is representative of a difference between said average error rate and the error rate determined from at least one new digital authentication code.

According to particular features, the method that is the subject of the present invention, as described in brief above, comprises a step of transmitting an alarm when said difference is greater than a pre-defined limit value.

According to particular features, the method that is the subject of the present invention, as described in brief above, comprises a step of associating a microtext to the digital authentication code, said microtext being printed with the digital authentication code that is associated to it.

According to a fourth aspect, the present invention envisages a device for checking the print quality, characterized in that it comprises:
a means of printing a digital authentication code carrier, utilizing print parameter values,
a means of capturing an image of the digital authentication code printed on said carrier,
a means of determining a print quality of the digital authentication code according to the image of the digital authentication code and
a means of printing at least one other carrier with print parameters according to said print quality.

This invention also concerns a method and a device for securing documents. It applies, in particular, to the printing of marks allowing an original to be distinguished from a copy.

Two large families of such marks are known: the images processed by steganography, i.e. bearing on a design, in a way indistinguishable to the eye, a watermark and the visible marks formed of a matrix of dots, each presenting one of two colors, generally black and white.

In each of these cases, a copy detection mark is produced in such a way that any copy, whether by photocopying or by taking an image and then printing the captured image, gives rise to a degradation of its details and allows this degradation to be detected, with a suitable reading and processing system. To determine whether a document is an original or a copy, the reading system measures the degradation and compares it, generally, to a pre-defined limit, or threshold, value.

However, the printing of the originals causes an initial deterioration in the printed mark and can make using this mark's anti-copy function impossible.

Certain aspects of this invention aim to remedy these inconveniences.

To this end, according to a fifth aspect, the present invention envisages a method for making a so-called “original” document secure, which comprises:
a step of determining characteristics of an item of equipment printing said original document,
a step of determining a mark allowing an original to be distinguished from a copy, according to characteristics of said print equipment destined to be utilized for printing said mark on said document,
a step of printing said mark with said print equipment to form said original document and
a step of determining a first limit value to be used by an item of copy detection equipment to distinguish said original document from a copy of said original document, according to at least one print of said mark.

Thanks to these provisions, the mark is optimized according to the characteristics of the item of print equipment and the limit value used by the detection equipment takes into account this print equipment's actual print quality.

According to particular features, the method, as described in brief above, comprises a step of printing at least one print reference representative of an authorized maximum or minimum inking for printing said document and, during the step of determining the first limit value, a measurement is determined over at least one said print reference and a tolerance is added to it.

Thanks to these provisions, in the authorized inking range, for a print context, it is ensured that each original document will be considered an original by the detection equipment.

According to particular features, the method, as described in brief above, comprises a step of measuring the deterioration of the mark on the print chain, a step of comparing this measurement with a second pre-defined limit value and, if the second deterioration limit value is exceeded, a step of warning.

It is noted that the second limit value can be identical to the first limit value. Thanks to these provisions, the printer can be automatically notified when the print quality degrades and rectify the print equipment's settings.

The fundamental and/or particular features of the different aspects of the present invention, as described in brief above, are intended to be combined to form a securitization method and device presenting all or part of the advantages of these various aspects.

According to a sixth aspect, the present invention envisages a computer program that can be loaded in a computer system, said program containing instructions allowing the method that is the subject of the present invention, as described in brief above, to be utilized.

According to a seventh aspect, the present invention envisages a data carrier that can be read by a computer or microprocessor, removable or not, holding the instructions of a computer program, characterized in that it allows the method that is the subject of the present invention, as described in brief above, to be utilized.

As the particular characteristics, advantages and aims of this device, this computer program and this data carrier are similar to those of the method that is the subject of this invention, as described in brief above, they are not repeated here.

Other advantages, aims and characteristics of the present invention will become apparent from the description that will follow, made, as an example that is in no way limiting, with reference to the drawings included in an appendix, in which:

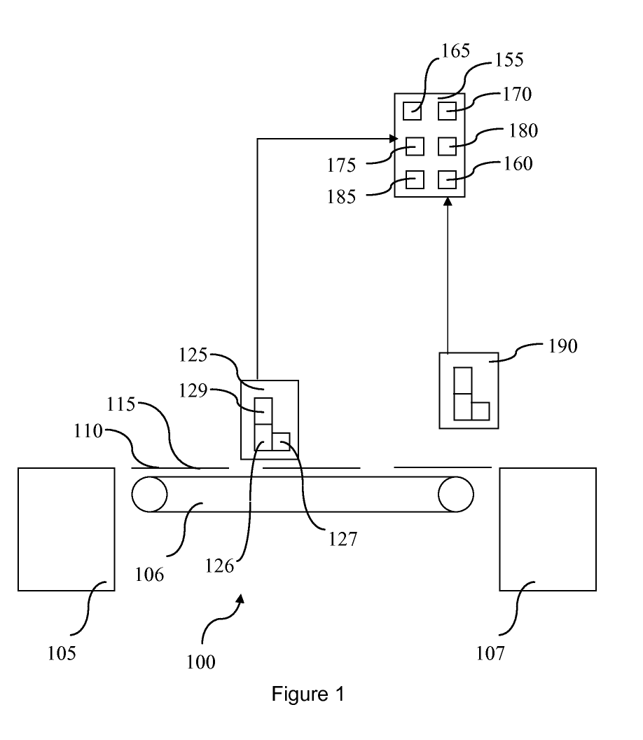

FIG. 1 represents, schematically, a particular embodiment of the device producing digital authentication codes that is the subject of this invention,

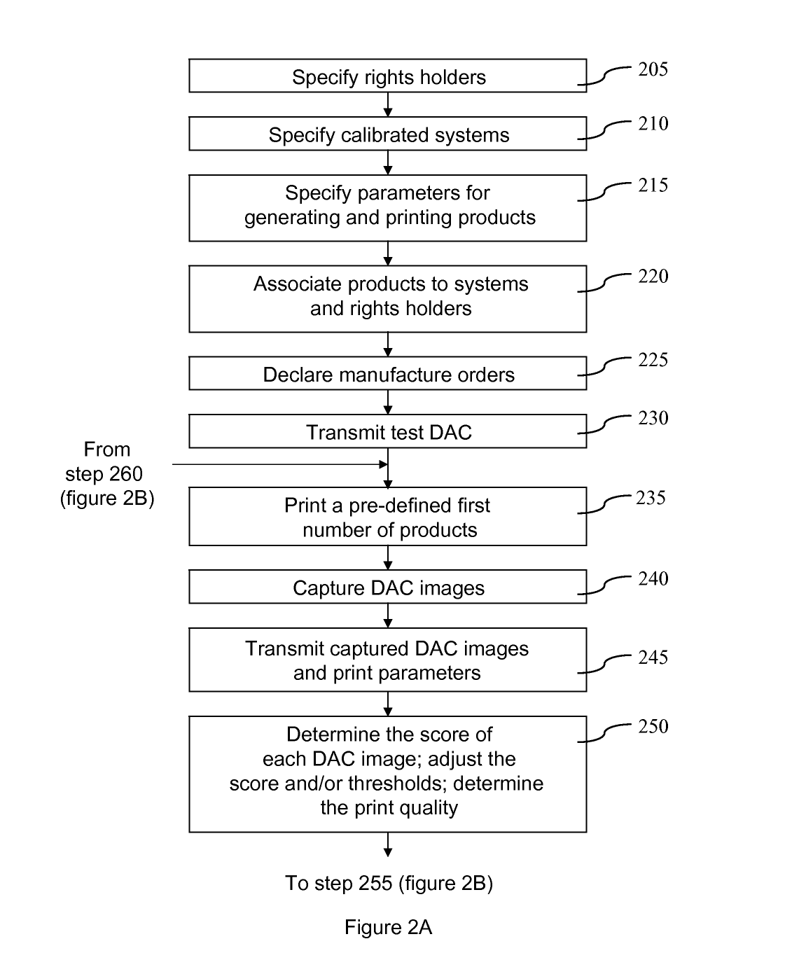

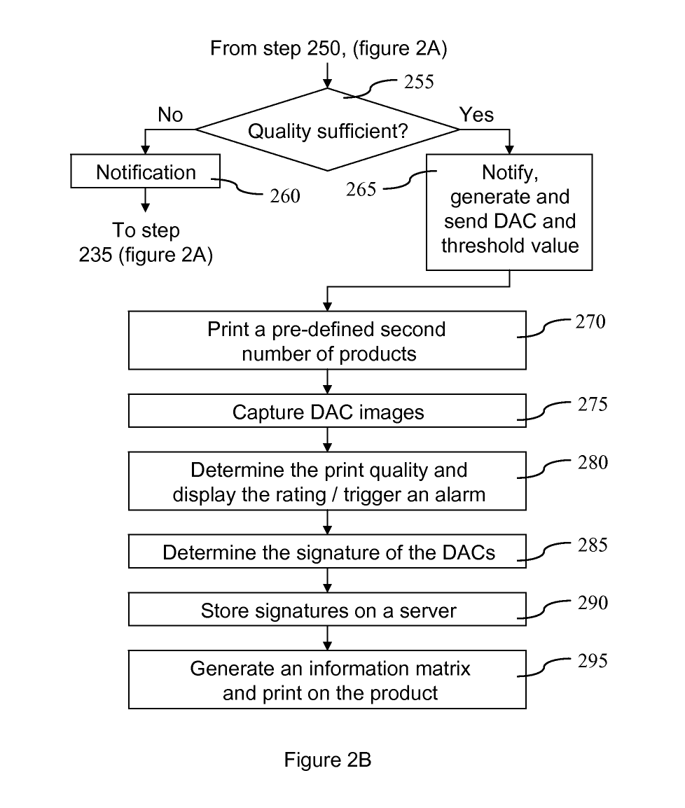

FIGS. 2A and 2B represent, in the form of a logical diagram, steps utilized in a particular embodiment of the method producing digital authentication codes that is the subject of this invention,

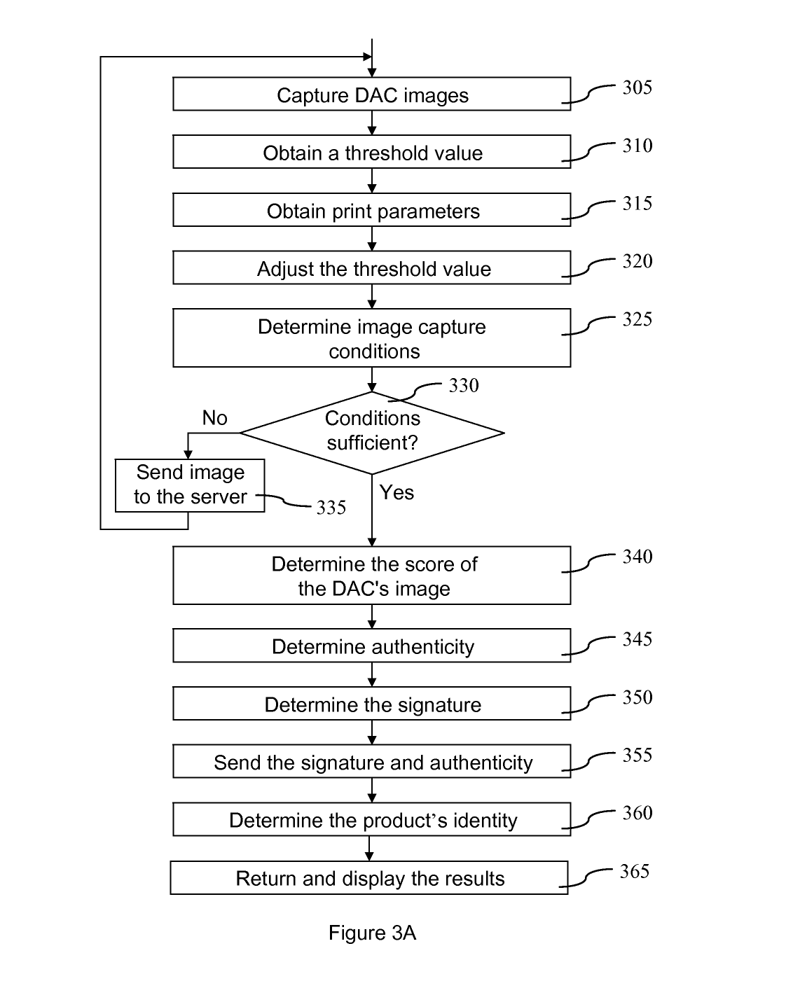

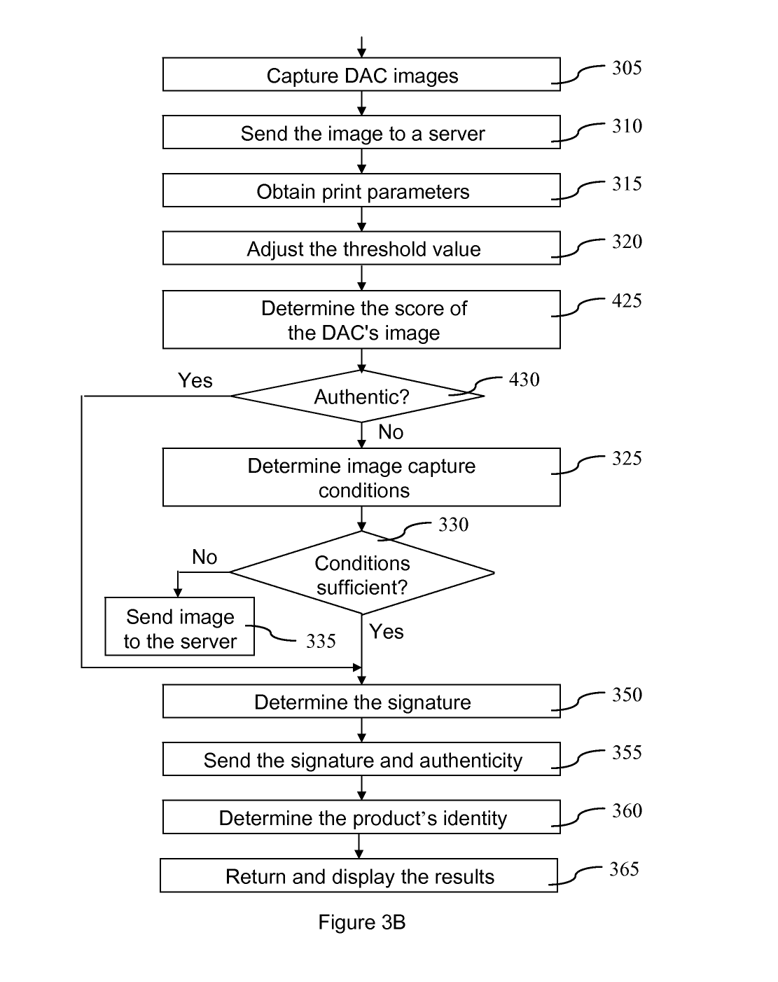

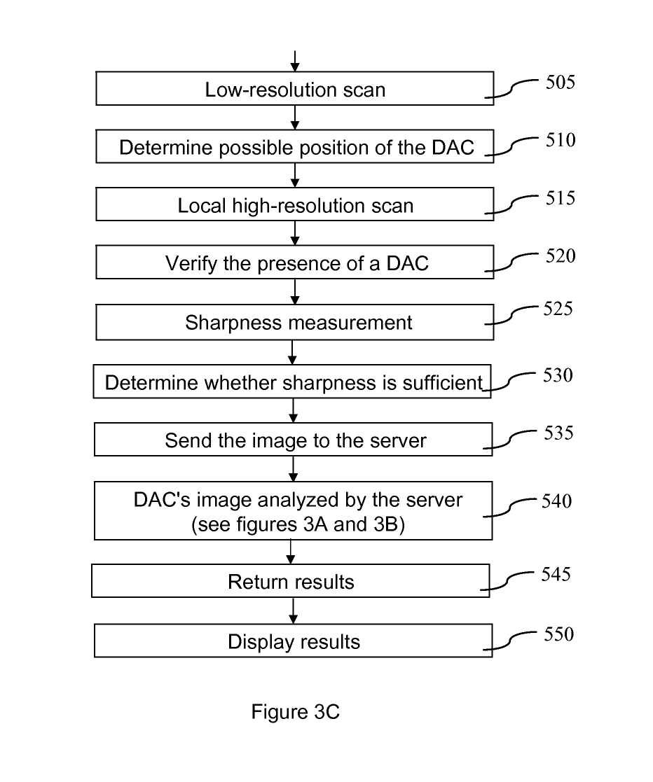

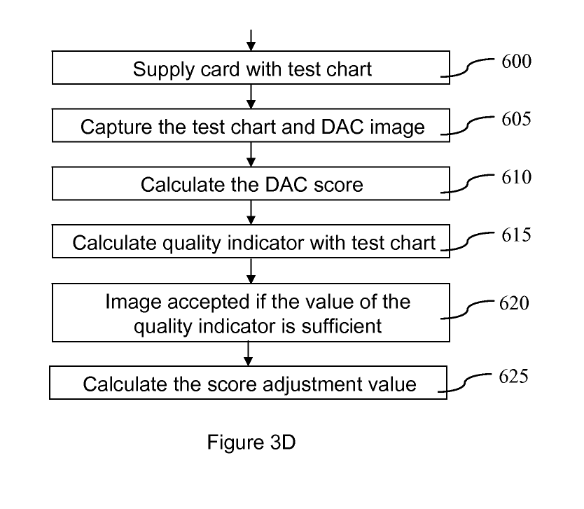

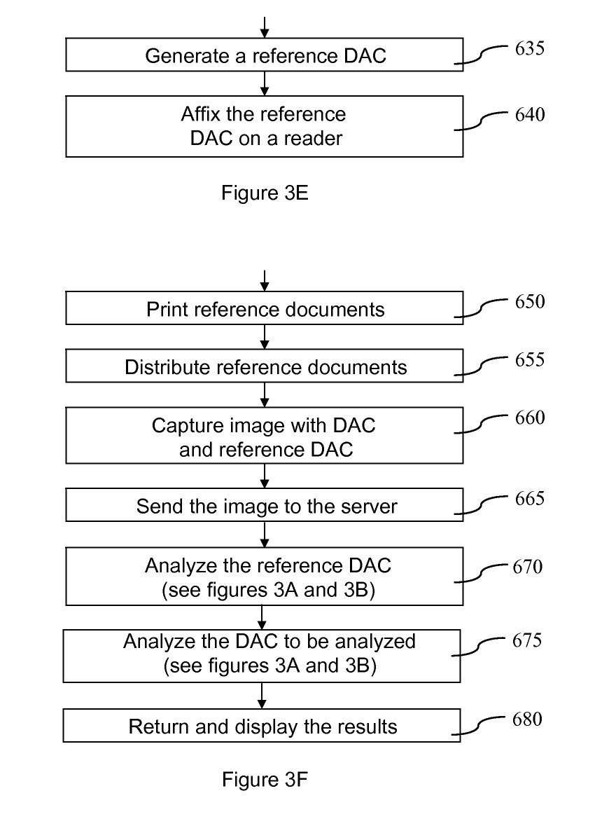

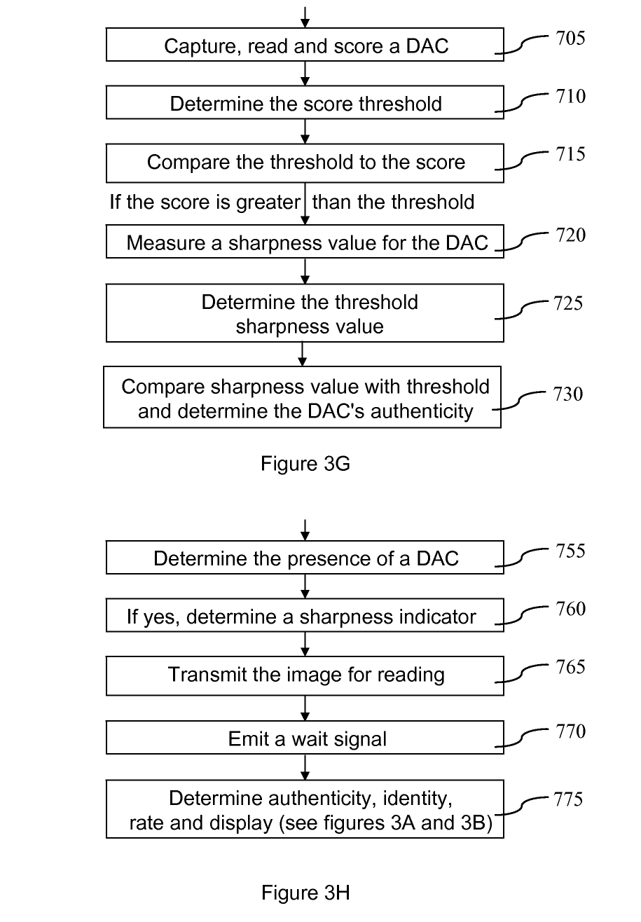

FIGS. 3A to 3H represent, in the form of a logical diagram, steps utilized in a particular embodiment of the method reading digital authentication codes that is the subject of this invention,

FIGS. 4 and 5 represent distributions of digital authentication code scores,

FIG. 6 represents statistical distributions of scores for originals and copies calculated based on images taken with a reference image capture tool and with an image capture tool of a lower quality,

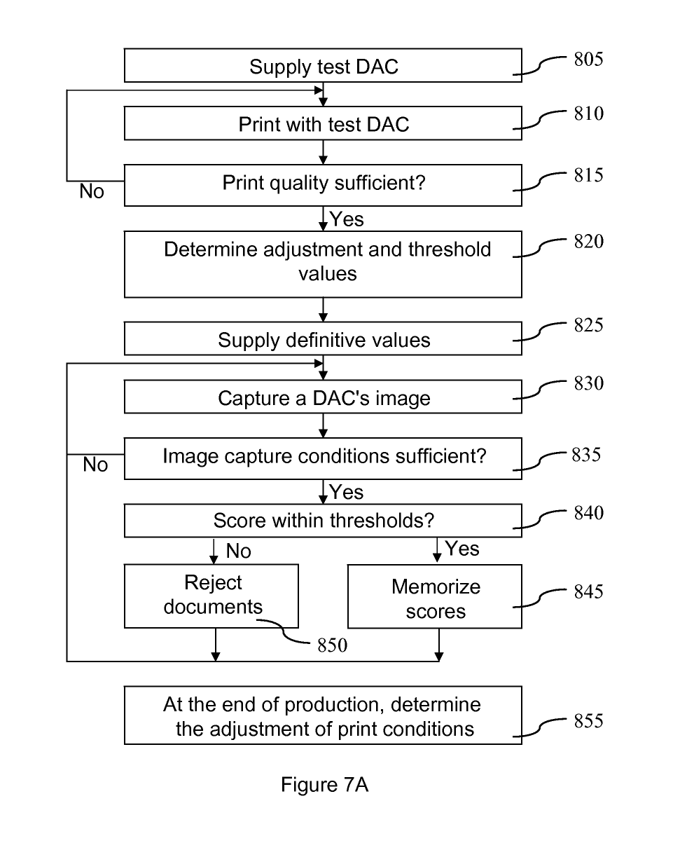

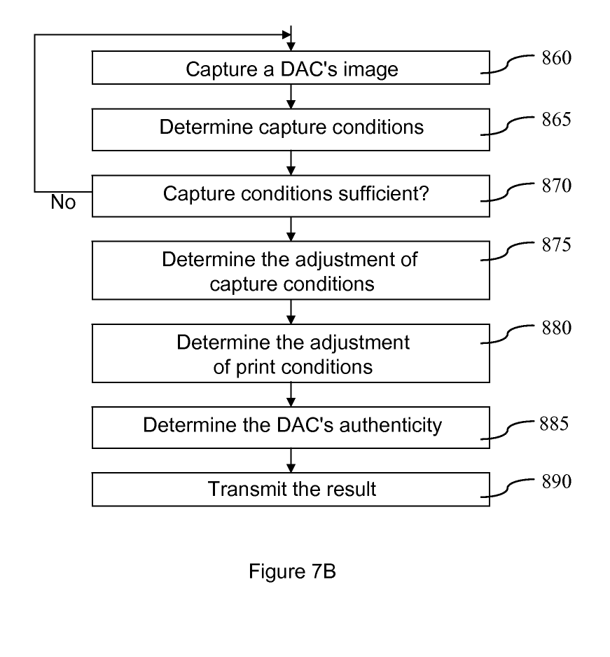

FIGS. 7A and 7B represent, in the form of logical diagrams, steps utilized in a particular embodiment of the method that is the subject of this invention,

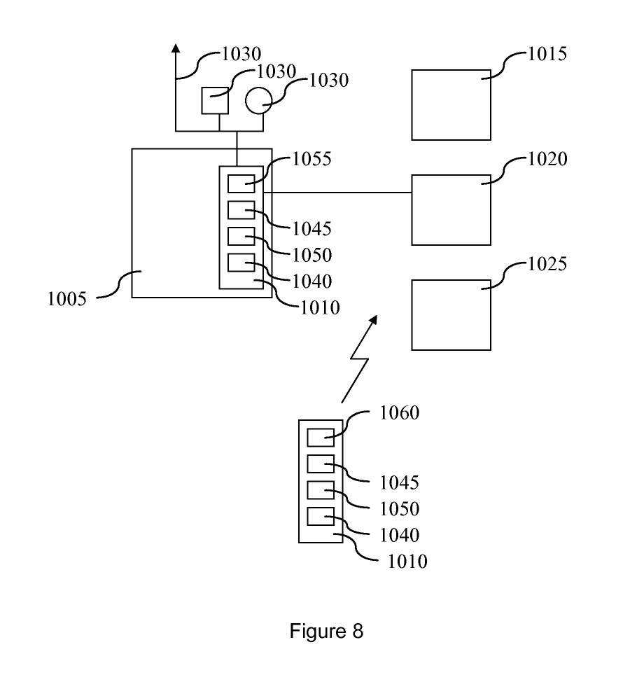

FIG. 8 represents, schematically, a particular embodiment of a device able to utilize the method that is the subject of this invention,

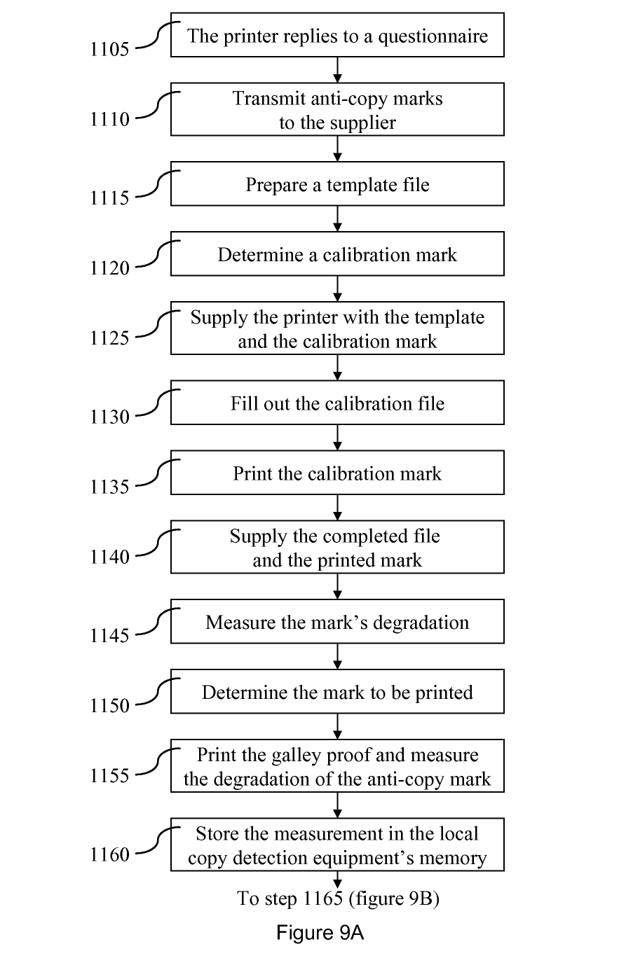

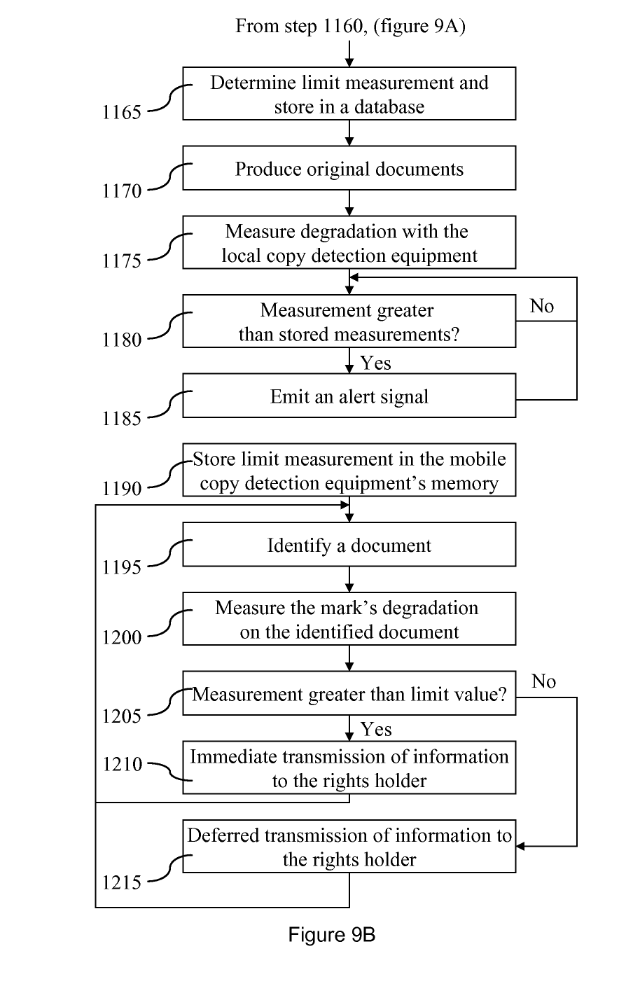

FIGS. 9A and 9B represent, in the form of a logical diagram, steps utilized in a particular embodiment of the method that is the subject of this invention.

Throughout the description, this invention is applied to digital authentication codes taking the form of square areas comprising square cells printed in black on a white background, the white areas presenting, in the initial digital image, the same surface area, in numbers of dots, or pixels, as the black areas. However, this invention is not restricted to this type of application but, quite the contrary, extends to any type of DAC digital image allowing original prints to be (automatically) distinguished from copies based on the measurement of a score of the digital image printed and then digitized, said score varying according to the quantity of degradation the image has undergone. In effect, all the DACs have the same problems of reliability and security with regard to controlling the score and checking the source image and:
to SIMs, CDPs, AMSMs and digital watermarks, some adaptations possibly being necessary in order to use one or other of the DACs;
to any shapes whatsoever, polygons or not, for both individual cells and all the cells
to any colors whatsoever,
to any number of colors whatsoever,
to any cell densities whatsoever on a given surface area and
to the DAC's integration or not in an existing image.

Before giving the details of the various particular embodiments of this invention, the definitions that will be used in the description are given below.
“information matrix”: this is a machine-readable physical representation of a message, generally affixed on a solid surface (unlike watermarks or digital watermarks, which modify the values of the pixels of an image to be printed). The information matrix definition encompasses, for example, 2D bar codes, one-dimensional bar codes and other less intrusive means of representing information, such as “Dataglyphs”;
“cell”: this is an element of the digital authentication code that represents a unit of information;
“document”: this is any (physical) object whatsoever bearing an item of information;
“marking” or “printing”: any process by which one goes from a digital image (including a digital authentication code, a document, etc) to its representation in the real world, this representation generally being made on a surface: this includes, in a non-exclusive way, ink-jet, laser, offset and thermal printing, and also embossing, laser engraving and hologram generation. More complex processes are also included, such as molding, in which the digital authentication code is first engraved in the mold, then molded on each object (note that a “molded” digital authentication code can be considered to have three dimensions in the physical world even if its digital representation comprises two dimensions. It is also noted that several of the processes mentioned include several processing actions, for example standard offset printing (unlike “computer-to-plate” offset), including the creation of a film, said film serving to create a plate, said plate being used in the printing). Other processes also allow an item of information to be printed in the non-visible domain, either by using frequencies outside the visible spectrum, or by inscribing the information inside the surface, etc, and
“capture”: any process by which a digital representation of the real world is obtained, including the digital representation of a physical document containing a digital authentication code.

By way of introduction to the description of particular embodiments of the method and device that are subjects of the present invention, it is recalled that the result of the degradation of a digital authentication code is that the contents of certain cells cannot be correctly decoded.

Each step of creating the digital authentication code is carried out with the aim of the original message being readable without error, even if, and this is a wished-for effect, the initial reading of the digital authentication code is marred by errors. In particular, one of the aims of this digital authentication code creation is to use the number or rate of errors of modulated message in order to determine a score, and then the authenticity of a print of this digital authentication code. In effect, a copy of the initial print of the DAC will generally bear more errors than this initial print of the DAC.

It is recalled here that the image of the digital authentication code is created from one (or possibly several) message and one (or possibly several) key: typically, the source message is transformed into a binary representation and then encrypted by the key; the encrypted message is encoded so as to be robust to a high number of errors, then the encoded message is scrambled by the key before being modulated in the form of an image, each binary value being represented by a pixel of the image forming the digital authentication code. The image forming the digital authentication code is printed at a resolution ensuring, from this initial print, an error rate that is significant (i.e. a low score) without being too high, such that the decoding of the encoded message containing the errors is guaranteed, as well as the detection of a possible copy of the digital authentication code, which necessarily comprises more errors.

In effect, the error rate, or the score, can be adjusted according to print characteristics, such that the production of a copy gives rise to additional errors, resulting in an error rate that is, on average, higher, or a score that is lower, when a copy is read than when an original is read.

In practice, an error rate of 20% during the original printing is adequate, even though rates from 5% to more than 30% can work. It is noted that, for an error rate that is too low, a copy that is perfect and therefore indistinguishable from originals may be feasible, while for an error rate that is too high, the digital authentication code may not be decoded correctly and there may no longer be enough information that can be degraded during copying.

The coded message extracted from a captured copied digital authentication code therefore has more errors than the coded message extracted from a captured original digital authentication code. In embodiments, the number or rate of errors detected is used to distinguish a copy from an original, by means of the score, which is a decreasing function of this error rate. In practice, a major challenge consists of determining an appropriate decision threshold allowing the best possible distinction between originals and copies.

Before describing a particular embodiment of the securization method that is the subject of this invention, a general presentation of the method utilized is given below. First of all, the rights holder orders a specified number of documents or products made secure by a DAC or DACs from an authorized processor or printer. This latter downloads one or more DACs, respectively for printing the same DAC on all the documents or for printing different DACs on different documents. Then, the processor prints the specified number of documents, with the specified DAC or DACs on each documents utilizing at least one aspect of this invention. The specified number of printed documents is sent to the rights holder. In a variant, the documents are sent to the assembler authorized by the rights holder. The rights holder or the assembler assembles the finished product (which can contain several “documents” made secure by DACs) and utilizes at least one aspect of this invention.

During this process, in a particular embodiment of the method that is the subject of this invention shown in FIGS. 7A and 7B, which only concern the utilization of the DAC authentication function, the rights holder authorizes the DAC provider to supply at least one DAC to the printer. During a step 805, the DAC provider supplies a test DAC and a pre-defined threshold value that can be dependent on the print conditions (type of carrier, type of printing, colors printed, image capture conditions). It is observed that the density (i.e. the ratio of dark areas to light areas) of this test DAC and each definitive DAC (see below) can be dependent on the document and print conditions.

During a step 810, the printer prints a pilot set of documents bearing the test DAC. During a step 815, it is determined whether the test DACs' print quality is sufficiently high, by analyzing DAC images and comparing their score against the threshold value. If the print quality is not sufficiently high, the method returns to step 810. If the print quality is sufficiently high, during a step 820 the DAC provider determines threshold values to be utilized during the production run, i.e. the printing of the documents to be delivered, and at least one DAC, which represents, possibly, at least one adjustment parameter value to be applied when determining whether an image of a DAC represents an original DAC, i.e. printed during the production run, or a copy of an original DAC. In a variant it is an information matrix supplied by the DAC provider that represents each adjustment parameter value. During the step 820, the DAC provider also determines threshold values to be applied during the production run.

Then, during a step 825, the DAC provider supplies at least one definitive DAC and threshold values to be applied during the production run, and possibly adjustment parameter values, to the printer.

During the production run, in a step 830, an image of a printed DAC is captured. During a step 835, it is determined whether the image capture conditions are sufficient. If not, the method returns to step 830. If yes, during a step 840, the image's score is determined, the operator is supplied with a rating representative of this score and it is determined whether the DAC's image corresponds to a score value, possibly adjusted, that lies between the threshold values supplied during the step 825. If yes, this score is stored during a step 845, the production continues and the method returns to step 830. Otherwise, an alarm is triggered during a step 850 and the documents being printed are rejected. Then the method returns to step 830, document acceptance only being resumed when the alarm is lifted.

When the production is finished, during a step 855, it is determined at least one adjustment parameter value (for example, additive or multiplicative) to be applied to the score of this production's DAC images according to the image capture quality, according to scores held in memory, and each adjustment parameter value is stored on the DAC provider's server. Each parameter value represents the DACs' print quality and/or conditions.

When the DACs are used, during a step 860, an image of a DAC is captured. Then, during a step 865, the image capture conditions are determined. During a step 870, it is determined whether the image capture conditions are sufficient, especially in terms of blurring, resolution and lighting, to allow the DAC to be interpreted. If not, the method returns to step 860 and/or the image is supplied to the DAC provider's server. If the image capture conditions are sufficient, during a step 875, it is determined at least one adjustment parameter value (for example, additive or multiplicative) to be applied to the score of the DAC represented by the image, according to the image capture quality, in particular the blurring, the resolution and the uniformity of the lighting. During a step 875, it is determined at least one adjustment parameter value linked to the print and one threshold value to be applied, either by reading a part of the DAC's content, or by reading a content of an information matrix, or by requesting this value from the DAC provider's server.

Then, during an 885, it is determined, according to the various adjustment values and the threshold value, whether the image represents an original DAC or a copy. During a step 890, the result from step 885 is transmitted to the DAC provider and, possibly, to the rights holder and, possibly, to the operator who performed the capture.

The utilization of the various steps illustrated in FIG. 7 is detailed in other particular embodiments of the method that is the subject of this invention illustrated in FIGS. 1 to 3H.

FIG. 1 shows an embodiment of the identification device 100 that is the subject of this invention adapted to a document printing machine, or chain, in order to process these documents from their initial printing.

The document identification device 100 comprises:
an unstacker 105, known per se, which unstacks objects, generally cardboard or paper sheets, or “documents”, 110.
a print chain 106, of known type, for printing at least one DAC on each document 110,
a stacker 107, of known type, which makes a stack of the documents 110 printed by the device 100,
a means 125 of reading at least one DAC 115 formed on a document 110,

The means 125 of reading the DAC 115 comprises a camera 126 and at least one light source 127.

The reading means 125 also comprises a means of processing 129 the image captured by the camera 126, which determines characteristics of the image of the DAC 115.

In a particular embodiment of the device shown in FIG. 1, the means 125 of reading the DAC commands a means of withdrawing (not shown) each document 100 bearing a poor quality DAC. In this way, the quality of each DAC is verified and all distributed documents benefit from the protection provided by utilizing this invention. The means of withdrawing each document 100 bearing a poor quality DAC is, for example, constituted of a “reject gate”, i.e. a shutter controlled so that, in one of its positions, the documents fall into a waste bin and, in another position, the documents are let through to the stacker 107.

The result of the verification carried out by the means 125 is transmitted, to be stored and used later, to a server 155.

This server 155 supplies digital authentication codes and has the following functionalities:
a means 160 of specifying the rights holders, the authorized processors, the calibrated or approved printers, the existing documents or products with all the parameters for printing or generating DACs relating to these products, and also the printers or processors; in addition the means of associating products to clients, printers to processors;
a means 165 for the rights holders to declare manufacturing orders relating to certain products, indicating in particular the quantities of DACs and/or products to be produced;
a means 170 for the printer to download, in a secure way, DACs that will be integrated into the product's design, automatically (especially in the case of variable printing) or manually; alternatively, a secure connection allowing a machine controlling the printing to download the DACs on request. Alternatively, for DACs that require the original image in order to be generated (especially digital watermarks), the means of sending an image to said server and receiving the marked image in return. In addition, a means of downloading the control file or files used by the software reading the DAC quality on the production line;
a means 175 of receiving DAC quality measurements, keeping these quality measurements, and determining whether the production is valid from these quality measurements. See below for the quality measurements, based on images captured on the production line. If the production is deemed valid, a message is sent to the processor allowing him/her to close the production session and deliver the products to the rights holder and
a means 180 for the person in charge of DACs to determine the products, machines, clients, printers and to modify the threshold values utilized for the DAC quality to be determined by the means 125 and
a database 185 of thresholds, or limit values, or authorized DAC degradation statistics for distinguishing an original, in correspondence with the identifiers of printed documents. As will be seen below, the database 185 is optional, a DAC being able, in embodiments, to incorporate at least one degradation limit value for distinguishing an original document from a copy.

A mobile means of reading DACs 190 is also shown in FIG. 1. The fixed reading means 125 and the mobile reading means 190 each comprise a means of communicating remotely with the server 155, for example, by means of a telephony network, fixed or mobile, or the Internet network.

Preferably, the integration of DACs for securing documents involves three parties: the rights holder wishing to produce secure documents, the provider of the service making documents secure via DAC, and the processor or the printer producing the documents secured by DAC. Sometimes, a party can have two roles to play, for example the rights holder is also the provider of the securization service, or this latter is also responsible for printing documents. However, even in these particular cases, the separation into three parties is relevant from a functional point of view since these are generally different departments that order, supply and print the DACs.

It is preferable to make the steps leading to printing DACs as secure as possible. Firstly, the access to the DAC images to be printed must be limited to trustworthy people. Secondly, the system must keep a complete audit trail in case of litigation. In an industrial context, there can be millions of DACs to be printed every day, involving several rights holders who deal with dozens of sub-contractors to produce hundreds of different types of products. Preferably, the complexity of the human operations, which are sources of errors, is minimized, the procedures are automated and logs are kept of the operations carried out.

In accordance with at least one aspect of this invention, in the course of the print process at least one printed DAC image is captured. Preferably, this process is done automatically, the products passing under the lens of the fixed reading means 125. This fixed reading means 125 is activated automatically or by an external activation from a capture device. In a variant, the mobile reader 190 is utilized by an operator to capture images of the DACs during production.

Each captured image of a DAC is stored in a database, with the associated information (manufacturing order, date, etc.).

When the DAC must perform a function identifying each product or document, in real time or deferred, one or more signatures, or imprints, are calculated for each valid captured DAC image. A signature allows one print of a DAC to be identified uniquely among the prints of the DACs coming from a single source image (of the same DAC).

The site where the images of DACs are captured can be located at the printer's, with the advantage that it can be integrated into the production, and the disadvantage that it is in an exposed area. The equipment used to calculate and/or store signatures can be secured, for example located remotely on the server and processing images supplied by one of the reading means 125 or 190. Alternatively, the site can be located at the third-party authorized by the rights holder, generally the same party that provides the DAC or DACs used.

With regard to the DAC copy detection function, the reliability of the copy detection depends on the stability of the score: from a statistical point of view, it is seek primarily to have the score with the smallest variance. That means that, from the beginning to the end of the production of products bearing a given DAC, the print conditions affecting the DACs' score must not change significantly.

However, this score is sensitive to a large number of parameters, for example the type of paper, the type of ink, and parameters generally adjustable on the print equipment, such as the ink density. Print equipment is often very sensitive, and experience shows that for the same product printed on the same machine, the print parameters can change for print series carried out at different times, with a significant impact on the DACs' score. In addition, the print parameters can change during a single production session, and a progressive shift of the score can thus be observed. Even a change of operator during the production session can have an impact on the print quality and therefore on the DACs' score. It is therefore seek to minimize these effects, in particular by providing for adjustments to scores.

According to at least one aspect of this invention, the marking conditions are checked during the production, in order to ensure the essential DAC copy detection function. Equally, it is not uncommon for the printer, or the person in charge of integrating DACs in the files, to make an association error, such that a wrong DAC value comes to be assigned to a document to be printed.

This type of problem must clearly be detected as soon as possible. If the reading means 125 is absent, an operator is equipped with a mobile DAC reader 190, in order to make regular checks of the production on the print chain. The reader can be very similar to a regular DAC reader. However, it is preferable that it has the following characteristics: for preference it is easy to handle, for example taking the form of a stand-alone reader, or by a wire-type connection with a sufficiently long wire. Its main function is to check the production quality, therefore a binary response is, in general, not very suitable; the readers being located in distant areas, i.e. at the printers or sub-contractors, it is better to store a minimum of sensitive information locally (read algorithms, reading parameters) in the reading means 125 and 190.

In a preferential implementation, the operator receives a file of sets of DAC reading parameters (these parameters can be transmitted automatically via the printer's internal network) and is equipped with a mobile reader 190, with a wire-type connection or not.

For preference, the set of parameters does not comprise the read keys, since there may be a security risk in distributing such a set of parameters. Therefore a sub-set of the DAC's values is stored, randomly sampled and of sufficient size to make it possible to measure a representative score for the quality check, but not large enough to recreate a DAC that is close to original DAC prints. If a DAC comprises, for example, 12,000 values, 2,000 of these values are stored in the file, chosen from positions that are random but known to the reader.

The operator reads the printing plate that bears it (for example, the one corresponding to the black ink), to make sure that the DAC has the right value and is of good quality. If this is not the case, he/she will have to produce a new plate, possibly with new DACs. Otherwise, he/she can start printing products in the preliminary print parameter adjustment phase. During this preliminary phase, the operator performs several checks of the DACs.

As FIGS. 2A and 2B show, the procedure for securing documents first of all comprises, carried out by a server that supplies digital authentication codes:
a step 205 of specifying rights holders, authorized processors/printers,
a step 210 of specifying calibrated or approved processing and/or printing systems,
a step 215 of specifying products/documents to be printed with parameters for printing or generating DACs relating to these products,
a step 220 of associating products to rights holders and processing and/or printing systems,
a step 225 of declaring manufacturing orders relating to products, indicating in particular the quantities of DACs and/or products to be produced and
a step 230 of transmitting digital authentication codes, in a secure way, to processing and/or printing systems for integrating in the product's design,

In variants, especially where DACs are used that require the original image in order to be generated, for example digital watermarks, the original image is sent to the server before step 230 and in the course of this step the server produces the DAC and sends it to the processing or print site. It is noted that the digital authentication codes sent in the course of step 230 are test digital authentication codes for integrating in the product's design.

Then a step of 235 printing a first pre-defined number of documents bearing a said digital authentication code is carried out, on the processing or print chain.

During a step 240, an image is captured of at least one, and preferably each, digital authentication code printed and an item of information representative of each printed digital authentication code is stored. This image capture can be carried out manually or automatically, by an image capture device placed on the chain in question.

During a step 245, captured images of the digital authentication codes printed are sent to the server, from the processing or print site, as well as print parameter values utilized for printing the pre-defined first number of products.

During a step 250, the server determines an error rate in the digital authentication codes represented by the images, then a score and a print quality for the pre-defined first number of products, with a possible adjustment according to print conditions and image capture conditions. Then, during a step 255, the server determines whether the production is valid based on measurements received, according to a pre-defined limit value, as described with reference to FIGS. 3A to 3D.

If the production is not valid, during a step 260, the server notifies the user or the print chain of this, with indications of the modifications to be carried out on the print parameters (for example to reduce or increase the inking). Then, the method returns to step 235.

If the production is valid, during a step 265, the server sends a message to the processing or print site indicating that the production is valid and also a digital authentication code to be utilized for the upcoming production. In embodiments, a score or error rate limit value, or threshold value, for the DACs' authenticity validation is determined by the server from rates determined during step 250. This value is represented, in a secure way, by the DAC transmitted during step 265. For example, this limit value corresponds to the authenticity validation of 98% of DACs printed during the last step 235. This value, together with an error margin, is transmitted to the reader on the chain and/or the manual reader. For preference, this DAC is also representative of print parameters utilized during the last step 235.

In a variant, the error rate, score and print quality are determined locally by the reader carrying out image captures and they are transmitted to the server 155.

During a step 270, a pre-defined second number of products, specified in the manufacturing order, is printed or processed utilizing the print parameters of the last step 235.

Then, during a step 275, for each product or for a portion of the products, an image of the printed DAC is captured, automatically or manually, on the print chain.

During a step 280, for each image captured during step 275, a rate of errors in the digital authentication codes represented by the images is determined, then a score and a print quality for the pre-defined first number of products, with a possible adjustment according to the print conditions and image capture conditions, according to a pre-defined limit value, as described with reference to FIGS. 3A to 3D. Then, the local reader determines whether the immediate production is valid according to the error margin, assigns a rating to the last image captured and supplies this rating to the print chain operator, by display.

If the production is not valid, i.e. if the error rate is greater than the authenticity limit value added to the error margin, an alarm is triggered in order for the operator to re-establish the print parameters. Possibly, the products for which the production is not valid are eliminated and deducted from the number of products printed.

During a step 285, in real time or deferred, one or more signatures are calculated for each valid captured DAC image. A signature, generally the one occupying the smallest volume of data, is quantified and/or compressed so as to obtain a compact representation of it. The set of calculated signatures is sent, by secure link, to the server which the inspectors connect to in order to verify the validity of signatures.

In a variant allowing the DAC to be verified, an information matrix, preferably made secure with the help of an encryption key, is generated to contain the representation of the signature and printed on the document containing the DAC, during step 285.

In a variant, a validity limit value, or threshold value, of the DAC is determined during production, from measurements made during step 280, and represented, in a secure way, by an information matrix printed during a step 295.

As is understood, during step 265, the set of parameters received by the operator contains an average target score for the DAC, together with error margins. For example, on a scale of 0 to 20, the target score can be 15 and the error margin +/−2. Thus, any score between 13 and 17 is accepted, but the wished-for score must be as close as possible to 15. This score is not generally presented to the operator, but a transformation of this score, called the rating, is presented to him/her, in the course of step 280, during production. This rating is easier for him/her to interpret, and can be compared between different production runs that might have different target scores. One possible transformation consists of transforming the score on a scale of −5 to +5, as follows:
if Score<target score-error margin: rating=+5
if Score>target score+error margin: rating=−5
otherwise: rating=5*(target score-score)/2*error margin

In our example:
Score<13: rating=+5,
Score>17: rating=−5
otherwise: rating=5*(15-score)/4.
   The operator's goal is to get, as far as possible, a rating close to 0, which corresponds to a score equal to the target score, in this case 15. He/she must at all costs avoid a rating of −5 or +5, which corresponds to an unacceptable score.

Thus, a score of 14.2 gives a rating of +1, and a score of 16 a rating of −1.25. To simplify, the rating can be quantified to the closest whole number.

The operator is asked for a minimum of readings, for example 30, taken in a uniform way during production, so as to determine the production's score statistics.

When the printer or processor wishes to close the production session, the quality measurements carried out during the production session are sent to the server, and a decision concerning the production's validity is sent in return.

Determining the Validity of the Production:

Several criteria can be taken into consideration: the number of values equal to +5 or −5, the average of the ratings, the average of the ratings as absolute values. In a preferential implementation, the production is deemed valid if:
the number of ratings equal to +5 or −5 is less than 3 and
the average of the ratings as absolute values is less than 4.

In a variant, a score that is greater than the target score is in reality more acceptable than a score that is lower than the target score. As a result there is a dissymmetry, which can therefore be integrated by assigning a greater error margin in the first case.

In a variant, the ratings displayed to the operator are transformed into ratings on a letter-grade scale, for example A, B, C, D, E with a + or − sign depending on whether the score is below or above the target score. For preference the rating is quantified beforehand. Then +5 corresponds to E+, +4 to D+, +3 to C+, +2 to B+, +1 to A+, 0 to A, −1 to A−, −2 to B−, −3 to C−, −4 to D−, and −5 to E−. The position of the +/− sign and the letter can potentially be inverted, since the sign is more significant.

It is noted that the target score and the error margin or margins are generally pre-calculated during a calibration phase for the printing machine and/or the ink and paper used and/or the target product, each able to have an impact on the DAC's score.

It is noted that, in order to increase the tolerance to specific print conditions, the adjustment phase can serve as a learning phase: a certain variation in the value of the target score can be tolerated, on condition that the whole production is as close as possible to this target score. In other words, the priority is to minimize the variability of the score, and provided the variability is low, it is acceptable for the production's average score to differ from the target score. In that regard, a message can be sent to the operator depending on the rating, for example recommending increasing or reducing the level of inking. In a variant, the printing machine is directly controlled so that the rating remains as close as possible to the value “0”.

The scores, or error rates, are therefore presented to the operator and counted in the production statistics.

In a variant, there is no step of transmitting analysis parameters to the processor, and the processor establishes a secure connection with an analysis server. The images are fed back to the server and the results sent to the processor's computer application, in real time.

It is observed that the statistics and the threshold value applied to the DAC's score (for determining originals/copies) can be established or modified after the production run is closed.

As FIG. 3A shows, the following is carried out in order to check the quality of the authentication codes:
a step 305 of capturing an image with one of the fixed reading means 125 or mobile reading means 190,
a step 310 of obtaining a limit value, or threshold value, to be applied to the error rate in order to determine a DAC's authenticity, for example reading the content of the DAC represented by the image, or by interrogating a database according to the content of the DAC or another identifier of the production,
a step 315 of obtaining print parameters, for example reading the content of the DAC represented by the image, or by interrogating a database according to the content of the DAC or another identifier of the production,
a step 320 of adjusting the limit value according to the print conditions, if this limit value does not take this into account as described with reference to FIGS. 2A and 2B,
a step 325 of determining image capture conditions in the course of which a resolution is determined for the DAC's image and/or blurring from poor focusing and/or blurring from movement during the image capture, according to known image processing techniques and/or utilizing a test chart, as described elsewhere,
a step 330 of determining whether the image capture conditions are sufficient,
if not, a step 335 of sending the image to the server 155 for additional image processing followed by a return to step 305,
if yes, a step 340 of determining the error rate in the DAC, an error rate also called the DAC's “score”,
a step 345 of determining authenticity by comparing the DAC's measured error rate, possibly adjusted according to the image capture conditions, with a threshold value,
an optional step 350 of determining the signature of each DAC for which an image has been captured,
a step 355 of transmitting the signature and result of step 345 to the server 155,
a step 360 of determining the product's identity by comparing the signature found to the contents of a database of signatures allowing the DACs to be identified and
a step 365 of transmitting processing results from the server 155 to the local image capture reader, for example with a view to displaying a rating, an identity and authenticity to the operator, rights holder and/or DAC provider.

As FIG. 3B shows, in order to check the quality of the authentication codes, in particular embodiments, the same steps as those shown in FIG. 3A are performed, except that steps 340 and 345 are eliminated and during step 425, which follows step 320, the error rate in the DAC's image is determined, then a score and, during a step 430, the product's authenticity is determined, as described with reference to steps 340 and 345 but without adjustment according to the image capture conditions. If it is determined that the product is authentic, step 350 is proceeded to. Otherwise, steps 325 and 330 are carried out and, if the image capture conditions are sufficient, step 350 is proceeded to.

In the case where a non-approved image capture tool is used, as shown in FIG. 3C, are performed:
a step of capturing an image by a capture tool, possibly not approved for the utilization of this invention, by carrying out:
   first, if a scanner is utilized, by carrying out a low-resolution scan, for example at 150 dpi, during a step 505,
   image processing to determine the position of the DAC, or each area potentially containing a DAC, in the image captured during step 505, during a step 510 then
   by carrying out a local scan, for each area potentially containing a DAC, to obtain a high-resolution image of the DAC, for example at 1,200 dpi, during a step 515,
by determining, from each image captured during step 515, for each candidate, if it really is a DAC (in contrast to a non-significant black square or a 2D bar code), for example by detecting in it the dark square outline of a pre-defined width with respect to the square's size, during a step 520,
by carrying out a first measurement of sharpness, based on the image of each DAC, for example by determining the average of the local gradients, in absolute values, during a step 525,
by comparing this first sharpness measurement with a value representing the minimum threshold sharpness value, so as to determine whether the candidate DAC's image is to be sent to the server, during a step 530,
by sending each selected candidate DAC to the server, during a step 535, by means of a computer network (in particular by electronic mail, or e-mail),
during a step 540, read each DAC, take a second sharpness measurement and compare the DAC's score and its sharpness score to the threshold values stored as reference, as described with reference to one of FIGS. 3A and 3B, all the steps being thus performed by the server 155,
during a step 545, depending on the result, return a result to the client computer in a message representative of the authenticity, the identity of the DAC and/or a rating and
a step 550 of displaying the content of this message to the user or operator, the rights holder and/or DAC provider.

This embodiment applies, for example, to images produced by flat-bed scanners. In certain applications, an image can be generated by different flat-bed scanners, which are not necessarily approved or even known. These scanners produce images of variable quality: in effect there are a multitude of brands and models of flat-bed scanner, and moreover most of these scanners contain internal settings that can affect the quality of the captured image.

Knowing the scanner model (this can be contained in the image file's metadata, or transmitted simultaneously by the scanner's operator) does not generally mean the image quality is determined: in effect, for a given scanner the capture resolution (600 dpi, 1,200 dpi, 2,400 dpi) affects the image quality, and this is different on different models of scanners. The type of image (color, grey-scale, binary) also affects the image quality. And even for a set resolution of a given scanner, there can be significant variations in quality. For example, the “smoothing” option of certain scanners corresponds to the application of a low-pass filter that can eliminate many details of the DAC, the score of which can therefore be reduced significantly. And other options can have a contrary effect on the score. Thus, options such as “Sharpness enhancement” correspond to a high-pass filter, which can sometimes increase or reduce the DAC's score. If a specific application is installed on the work station connected to the scanner, in theory it may be possible to “freeze” the different capture parameters in order to check the image quality. But in practice this is unfortunately not possible in a reliable way, since the scanner parameter management programs are proprietary programs, and do not give access to a majority of the internal parameters other than by a user interface, which can therefore be changed at any time without control. Finally, the document to be verified can simply be poorly placed on the surface of the scanner, in such a way that the DAC's image is not taken at the scanner's focal point: its score can therefore be significantly affected by this.

In certain applications, the image capture tool can be of an unknown origin. For example, in certain cases, an image can be taken on any scanner whatsoever, then sent to a server for verification. The name of the scanner is not transmitted to the server, and even if it was transmitted its image capture properties may be unknown, given the large number of models on the market.

To overcome these difficulties, and thus allow the large-scale deployment of DAC reading applications without necessarily controlling all the reading parameters or installing a local application (remote reading), one solution consists of distributing test charts to the operators of the image capture tools, during a step 600, shown in FIG. 3D. A test chart is an object, for example a card, that contains image structures allowing the quality of the image produced by the image capture device to be evaluated in an accurate and stable way.

The operator who has a test chart and wishes to authenticate a document places the test chart and the document alongside each other in the image capture device's field of vision, in such a way that a single image capture contains both the DAC or DACs to be analyzed and the test chart, during a step 605.

An image of the test chart allows one or more indicators of the image quality to be calculated. These indicators are matched with reference values for the test chart, so as to adjust the DAC's score by taking into account the measurement of the image quality, during a step 610 and 615 and/or to determine whether the image is of a sufficiently high quality to determine the DAC's authenticity.

The test chart can also be a sticker that is stuck on the document to be verified, alongside the DAC. In this way, if the DAC is poorly positioned on the scanner so that it is blurred in the image generated, there is a strong chance that the test chart will also be blurred. It will therefore be possible to determine that the image does not allow the DAC to be authenticated. In a preferential embodiment, the test chart itself contains a DAC.

An example of the steps for utilizing the test chart is given below:
during step 610, a score is calculated for the DAC,
during step 615, an indicator of the image quality is calculated from the test chart,
during step 620, if the quality indicator is below a pre-defined threshold value the image is rejected, i.e. additional analyses are requested,
if the quality indicator is above the threshold value in question, during a step 625, a multiplicative adjustment coefficient or an additive coefficient to be applied to the DAC's score is calculated from the indicator value, and the DAC's adjusted score is calculated from its initial score and the multiplicative or additive coefficient.

The adjusted score is compared against each pre-defined threshold value for the DAC so as to make a decision concerning its authenticity, its signature, its rating and the identity of the product, as described with reference to FIG. 3A or 3B.

Image quality problems can exist even with reading tools with properties that are, in theory, known. In effect, in practice a pool of readers is distributed to the sub-contractors, assembly units, quality department of the various rights holders and also to inspectors, customs officers, distributers. These readers are moved and operated with variable precautions, and sometimes some readers are out of adjustment. In addition, a reader may not be perfectly adjusted when it leaves the factory. And in general it cannot be guaranteed that all the readers have exactly the same reading performance levels, even if they are manufactured in an identical way. According to at least one aspect of this invention, the scores, or the decision threshold values, are adjusted so as to take the tool's performance into account. For preference, means of detecting an adjustment problem on a reading tool are provided for.

One solution to these problems consists of integrating a test chart (such as those described earlier) in the field of vision of the image capture means in a fixed way, such that the test chart is contained in every image captured with the capture means. Thus, each time an image is read, reading the test chart allows the image quality to be measured. This image quality can be taken into account in order to adjust the score measured for the DAC, or to display a message warning the operator of the reading means that an adjustment of this reading means is needed.

The steps utilized are therefore, as shown in FIG. 3E:
a step 635 of generating a reference DAC used as gauge and certification of the readers and
a step 640 of affixing these DACs on each of the authorized reading means, in its field of vision (for example by engraving or gluing a reference DAC carrier).

When the performances of the image capture means are not known and a test chart is not available, it is nevertheless possible to make sure that a document looked at is an original. In effect, a threshold value can be established beforehand, corresponding to the best reading quality that can be obtained over a range of reading means. For example, the range of reading means can correspond to all flat-bed scanners operating at 1,200 dpi. The threshold value can be established by one of the methods described above. When the score obtained is compared to this threshold value, the DAC is considered to be an original if the score is greater than the threshold value. In contrast, if the score is below the threshold value it cannot be concluded that this is a copy, or an original captured with an inferior image quality. In this case, the response message generally consists of recommending a more detailed verification, with the help of an image capture means with known performances, or otherwise with an image capture means providing a superior image quality.

The card equipped with the test chart can have other advantageous functions. For example, the test chart can contain information, for example in a DAC or SIM, allowing its holder to be identified. Thus, it can be ensured that only authorized people can read or authenticate the DACs. It can also be determined the DACs read for a given test chart, or even allow a maximum number of reads for a given test chart. This is also true if the test chart is on a sticker, as this can be destructible if one tries to remove it.

The reading means also makes it possible to draw up a payment model for the DAC reading service customer based on the number of reads performed.

Copy detection methods can be applied so as to detect a possible copy of a reading card.

It should be noted that these functions can be implemented without the card containing a test card.

The steps utilized can be those shown in FIG. 3F:
a step 650 of printing documents serving both as reading certificate and reading gauge, containing a reference DAC serving as both reading certification and reading gauge,
a step 655 of distributing reading certifications to authorized people.
a step 660 of capturing an image by a non-approved capture tool, said image containing both a document containing a DAC and a document containing the certification DAC,
a step 665 of sending the captured image to a secure server, by means of a computer network (in particular by electronic mail),
a step 670 of analyzing the certification DAC of the captured image by the secure server 155,
a step 675 of analyzing the DAC of the document for the captured image by the secure server,
a step 680 of sending a message, by the secure server, specifying whether the certification DAC authorizes the reading, whether the image capture conditions authorize authentication, and if yes, if the DAC of the captured document is authentic or is a copy, possibly the identity of the product and/or a rating.

It is noted that the estimation of blurring processed during the image processing can also be due to a poor print quality. Therefore, print sharpness values are obtained, that can, for example, be pre-calculated during the image checking step and stored by the server 155. The steps utilized comprise, as shown in FIG. 3G:
a step 705 of capturing an image, reading/extracting the message) and measuring the DAC's score,
a step 710 of determining the DAC's threshold score value (for example, stored on the server or in the message),
a step 715 of comparing the DAC's score to the threshold value: if the error rate is less than the threshold value, the product is determined to be an original, and if not:
   a step 720 of measuring a sharpness value for the DAC (this step can be done automatically during the step of reading the DAC),
   a step 725 of determining the DAC's threshold sharpness value (for example, according to the message contained in the DAC, depending on the identification of the DAC),
   a step 730 of comparing the sharpness value to the threshold sharpness value, and on output, a determination of whether the product is a “copy”, if the DAC is sufficiently sharp, or whether the image is “non-compliant”, if the image is not sharp.

In a variant, the degree of sharpness can, up to a certain tolerated value, be used to adjust the DAC's score.

In a variant, the method has complete control over the print context, and can store the expected value or threshold value for sharpness (as well as the threshold score value) in the message carried by the DAC; the method can also store these values in a 2D bar code during printing by overprinting.

In the case of a reading tool that captures images serially, an algorithm presented in FIG. 3H enabling blurred images to be determined in real time can be used. If the image contains a DAC and is judged to be sharp, the DAC can be authenticated, otherwise the method continues. It is noted that it may be possible to tolerate a certain number of good but rejected images. In contrast a systematic rejection of valid images (for example a non-blurred copy) is not acceptable.

The threshold value of the sharpness score can be absolute or determined according to the print conditions if these are known. For example, depending on the sharpness measurement, scores with different values for DACs that are offset printed can be obtained, or ink-jet printed (typically less high in the latter case). It is noted that the sharpness measurement can also vary according to the properties of the image capture tool and the resolution at which it is used. If necessary, the sharpness measurements are converted to take these properties into account, and the parameters of the sharpness measurement algorithm can also be adapted (for example the size of the neighboring area in question, which typically is larger if the capture resolution is higher).

The steps utilized are therefore as follows:
a step 755 of determining whether an image contains a DAC (for example by detecting a square if the DAC is square),
if yes, a step 760 of measuring a sharpness indicator, for example the average measurement of the absolute gradient value over the image portion containing the DAC (certain DACs are very textured), and comparing to a pre-defined threshold value,
if the sharpness measurement is greater than a pre-defined threshold value, a step 765 of transmitting the image to a DAC reading module (this latter can be on a different machine from the one that utilizes the sharpness measurement functions). In a variant, the operator can force the reading by pressing a button provided for this purpose, for the case in which the sharpness measurement is systematically lower than the pre-defined threshold value,
according to the estimated analysis time, a step 770 of transmitting a signal to the operator indicating that an image has been read and
a step 775 of determining the authenticity and/or identity and/or rating and displaying the result of the reading to the operator, the rights holder and/or DAC provider, as described with reference to FIGS. 3A and 3B.

In a variant, an image difference is measured between the image received and the previous image, and the image is rejected if the difference measurement is greater than a threshold value. In effect, a large image difference can indicate that the product or document is in movement and that its position is not stabilized, which increases the chances of the image being blurred.

In a variant, the measurement of a sharpness score in the test chart is integrated in the algorithm given above.

It is noted that there are many sharpness measurements that can be used, several of which are described in “Autofocus survey: A comparison of algorithms” by Loren Shih. The Sobel gradient filter provides good results, and is not very costly in terms of calculations. Equally, the subtraction of an image and the result of the low-pass filtering (for example by Gaussian filtering) of this image results in an image of differences, these differences being much more marked if the image originally contained significant energy in the high frequencies. The average of these differences (taken as absolute values), or an average of these differences over a selection of the image containing the greatest number of differences, provides an indicator of sharpness.

It has been seen how a scanner-based remote reading application can verify the image quality with the help of the test chart. This application is advantageous because no software has to be installed at the user. In contrast, the application entails several operations (setting the scanner's parameters correctly, possibly selecting the image part to be scanned, saving the digital image, or “scan”, in a file, sending the file to the server by electronic mail). However, many users may not necessarily be familiar with this type of operation, and as a result will not use the application. In addition, an operation error can easily occur, resulting for example in an image file that does not contain a DAC, or an image that does not have the required quality. These errors are only noted after the server's response, which can take some time. Many users are likely to be discouraged by the difficulty of using the application, and it is probable that a number of them will avoid using it.

Installing local application software means that reading can be substantially simplified. Preferably this local application software does not contain the DAC reading algorithms, or the related keys. In this way, the related security problems are avoided. Secondly, the problems of updating keys or parameters in the installed application software are avoided. On the other hand, the local application software manages the scanner's parameters, determines the areas to be scanned, sends the DAC images to the server, and displays the server's responses on return. It can also detect problems, for example blurred images, before the image is sent to the server and indicate to the user how to correct these problems.

On the server, the DAC or DACs are read. For each DAC a sharpness measurement can be taken and compared to a threshold value stored on the server (this value can be retrieved if the DAC is identified). If the DAC's score is less than the threshold value corresponding to it and the sharpness measurement is also less than the threshold value corresponding to it, a message can, for example, be sent to the operator of the scanner, rights holder and/or DAC provider, indicating that it was not possible to authenticate the image.

It is noted that the threshold value applied to the sharpness score can have been calculated when the production run was closed, based on images from the quality check. FIG. 3C shows the steps utilized in this particular embodiment.

The error rate (or quality) and sharpness scores can vary according to the image capture conditions: quality, resolution, lighting, etc. The measurements made during calibration (see FIGS. 2A and 2B), during the quality check in production or during delivery of products to the processor or any other recipient designated by the rights holder, which serve as a reference for the expected measurements, must be adapted to the image capture conditions if they have been carried out with an image capture tool producing different types of images.

To carry out an adjustment of the scores and/or threshold values according to the image capture conditions and/or application conditions, a printed DAC (or several prints of the same DAC), serving as a reference, is chosen. Preferably, this DAC is correctly printed with no particularity, for example its level of inking is not too high. Several image captures are carried out with the reference image capture tool, for example the one that serves in the quality check in production or when documents are received. An average, “m”, and a standard deviation, “e”, are calculated for the score, for example, by using robust statistical methods. For an image capture with this tool, with no assumption concerning the score for copies, the threshold value is fixed at s=m−n*e, where “n” is a positive value that depends on the maximum probability of the false detection of a copy that is acceptable. As discussed previously, a certain number of good quality copies can be created by re-printing under the same conditions, and several image captures can be carried out in order to determine the statistical distribution of the scores, or apply a simple model that allows estimating the score obtained during a good copy, i.e. by utilizing print tools with a quality similar to that of the original's print tools.

Assume that the image capture tool is different from the image capture tool used when calculating the statistical distribution of the scores. In general, but not necessarily, the image capture tool will be of poorer quality, such that the average “m′” of the scores for this tool is less than “m”. In all cases, a conversion function “f” of the scores between the two image capture tools is calculated: to do that, DACs are printed with different print qualities. Images of these are captured with the different image capture tools used, and the conversion function that has to be applied to the different levels of score obtained with these different image capture tools is determined. For example, the conversion function is considered to be an additive or multiplicative type, and the multiplier or additive coefficient to be applied is determined. For example, if the average of the scores is 13 for a DAC sample with the reference tool, and this average is 11 for the tool used in production, a multiplicative coefficient of 13/11 can be used whatever the score is. For example, a score of 15 with the image capture tool will be transformed into 15*13/11=17.72 before being compared against the threshold value. In this way, the shift in the scores explained previously is corrected, and the risks are minimized of the poor classification of the DACs that can result from this.

However, this solution cannot always be applied since, as previously discussed, the image capture tool used is not always known. On the other hand, in certain cases, an image of a test chart has also been captured during the image-taking and, for preference, this test chart contains another DAC for which the score on a reference tool is known. It has been seen previously how this test chart can be used to determine whether the image quality is sufficient. This test chart can also be used to adjust the score obtained for the DAC to be authenticated. For example, if the DAC serving as a test chart obtains a score of 12, while this score is 13 on average on the reference image capture tool, a multiplicative coefficient of 13/12 can be applied to the score of the DAC to be authenticated. Compared to the method described previously, which simply judges whether the image-taking quality is sufficient, based on the test chart, this new method makes it possible, within certain limits (a score below a pre-defined limit for the test chart's DAC leading to the captured image being rejected), to carry out a score adjustment that, although it may be approximate, nevertheless allows the risks of errors (in particular the risks of considering a original to be a copy on a poorer quality image capture tool) to be reduced.

However, in certain cases a test chart is not available when the image is captured. In that case, the image quality can be estimated in various ways, for example by applying low-pass filtering, preferably Gaussian, to the image, and by measuring a difference, for each image pixel, between the filtered image and the original image, then by calculating an average for the image difference. An average can also be calculated by favoring the DAC areas with a greater contrast. In general, the image-taking quality will get less as this difference gets smaller. It is noted that other analog methods, for example based on measuring the power spectrum in frequency for the captured image, can be used as an indicator of sharpness.

In this method, the relationship between the sharpness indicator and the score correction factor must be predetermined. For example, one or more printed DACs with the same print quality are chosen, and their score and sharpness indicator are calculated on image capture tools that have different qualities. The relationship between the sharpness indicator and the score correction coefficient can then be estimated by statistical methods. The same procedure can be repeated for DACs with different levels of print quality, and therefore different levels of score, when the image is captured with a reference image capture tool. It is noted that, for the best results, it is preferable to take the possible differences in image capture resolutions into account in calculating the sharpness indicator and also the image's dynamic.

Throughout the rest of the description, “document” is used to refer to any information carrier readable with reading equipment and, sometimes, by eye and “anti-copy mark” or “mark” is used to refer to a mark intended to be made, by printing or by local physical modification of the carrier, on a document and whose degradation, when this document is copied, is detectable and allows the original to be distinguished from the copy. It is recalled that there are two large families of such marks: the images processed by steganography, i.e. bearing on a design, in a way indistinguishable to the eye, a watermark and the visible marks formed of a matrix of dots, each presenting one of two colors, generally black and white.

FIG. 8 is not shown to scale, either. FIG. 8 shows an item of printing equipment 1005 equipped with an item of copy detection equipment 1010, a server 1015 providing anti-copy marks, a server 1020 holding a database of authorized degradation measurements, a server 1025 of an owner of rights on a document, warning means 1030, for example a rotating light, a sound emitter or production control computer and an item of mobile copy detection equipment 1035.

The printing equipment 1005 is of any type whatsoever, for example flexography, gravure, offset, typography, digital, laser or ink-jet printing.

The copy detection equipment 1010 and 1035 comprise a means of taking an image 1040 of a mark on a document, for example a charge transfer image capture device, known under the name “CCD” (acronym for “charge coupled device”), a processor 1045 and a non-volatile memory 1050 holding a software system implementing steps shown in FIGS. 9A and 9B.

The copy detection equipment 1010 also comprises a means of remote communication 1055 with the server 1020 and/or the server 1015, for example on a fixed or mobile telephony network.

The copy detection equipment 1035 also comprises a means of remote communication 1060 with the servers 1020 and 1025, for example on a mobile telephony network.

The server 1015 providing anti-copy marks is designed to implement step 1165 shown in FIGS. 9A and 9B to provide an anti-copy mark according to the printing equipment characteristics.

The server 1020 holds a database of authorized degradation measurements matched with identifiers of printed documents. As will be seen below, the server 1020 is optional, an anti-copy mark being able, in embodiments, to incorporate the degradation limit measurement or measurements allowing an original document to be distinguished from a copy.

The server 1025 of an owner of rights on a document is designed to archive and process information from the mobile copy detection equipment 1035 to determine a document's route, especially in the case when a copy is detected.

During a step 1105, a printer fills out a questionnaire describing, in particular, the type and brand of an item of printing equipment intended to be used for printing documents bearing an anti-copy mark, and all the graphics chain parameters, for example of the “CAP” (acronym for “computer-assisted publishing”) system of the “RIP” (acronym for “rastering image process”) system which is expressed in a “bitmap” file, i.e. representing each dot of the image separately for each color and the “CTP” (acronym for “computer to plate”) system or “FTP” (acronym for “film to plate”) system, which engraves the printing plate.

During a step 1110, the completed questionnaire is supplied by the printer to a provider of anti-copy marks.

During a step 1115, the provider prepares and supplies a template of calibration files to the printer, according to the contents of the completed questionnaire, which represents the physical configuration of the printing machine. For example, from the width, the supplier determines where to place the template (for example a dimension of 105×210), given that this template is to be reproduced several times on test sheets. Preferably, it is set up for the template to allow each color printed (each print group) to be identified since an anti-copy mark is integrated for each print group. In other embodiments, an anti-copy mark is only provided for the color, for preference black, with which this mark will be printed.

During a step 1120, the provider of marks determines a calibration mark, according to the contents of the completed questionnaire. Knowing the native resolution of the printing equipment, generally 2400 points per inch, the resolution of the anti-copy mark is chosen so that the original's print itself comprises a sufficient mark degradation, for example greater than a pre-defined value.

During a step 1125, the provider supplies the file template and the calibration mark to the printer, preferably in an attachment to an electronic mail.

During a step 1130, the printer completes a calibration file, i.e. during the design of a test sheet comprising several files intended to be printed in different places and in different colors, he/she adds a mark, for example a cross, in a box corresponding to the print color and position. Similarly, he/she identifies the equipment used for printing. During this step 1130, the printer associates an anti-copy mark supplied during step 1125 to each file realized based on the template.

During a step 1135, the printer prints the calibration mark with the printing equipment, preferably in different central and side print areas of the printing equipment and preferably for the most common reference cardboard in production. In a variant, the printer prints the mark on different types of paper or cardboard, in different paper weights.

During a step 1140, the printer supplies the completed calibration file and the mark or marks printed by the printing equipment to the provider of marks.

During a step 1145, the provider measures the degradation of at least one anti-copy mark printed with the printing equipment with a view to statistical processing to determine a standard deviation between the file prints.

During a step 1150, the provider of marks determines the characteristics of an item of printing equipment, according to the degradation of at least one mark printed with the printing equipment to be used and supplies a mark having these characteristics to the printer, who integrates them in the matrix of the document to be printed, for example the offset films. For example, the provider determines, statistically, a standard deviation for the number of print errors of the anti-copy mark printed during step 1135. Depending on this standard deviation, the utilization capacity of the printing equipment and its context are verified. Possibly, during step 1150, the provider adjusts the print resolution of the anti-copy marks.

When a production run of original documents is started, the printer utilizes a galley-proof printer. It is noted here that a galley proof is a physical print sample of the document, accepted by the principal in terms of the processing quality. It is signed by the customer and serves as a reference standard or setting standard for the printing equipment at the start of each production run. This is a very widespread work tool and is systematically used in the print world. The galley proof corresponds to three print situations:
printing with the minimum acceptable inking load,
printing with the ideal inking load and
printing with the maximum acceptable inking load.

During a step 1155, an item of copy detection equipment is utilized to measure, on at least one of the extreme panels of the galley proof corresponding to an extreme inking load, the degradation of the anti-copy mark. The standard inking, represented by the galley proof's central panel, defines, by means of the copy detection equipment, a standard error rate, or degradation measurement. Preferably, the measurement is performed at least on the galley proof panel presenting the minimum inking load authorized by the customer. Preferably, each panel is the subject of a degradation measurement and the highest degradation measurement is selected. It is recalled that a degradation measurement can determine the number of the mark's dots that do not have the digital original's color. This measurement can be carried out by comparing an image of the analyzed mark with a digital image without degradation, for example.

During a step 1160, an item of information representative of the degradation measurement obtained during step 1155 is stored in the memory of an item of copy detection equipment installed on the item of printing equipment. This item of information is, for example, the error rate measurement for each extreme inking load authorized.

During a step 1165, a safety margin, for example a multiple of the standard deviation, is added to the degradation measurement obtained during step 1155 for the standard inking and the result is stored. In embodiments, two limit values are determined, by adding or deducting the safety margin of the error rate obtained with the standard inking load.

In embodiments, the storage is done in a remote database (see server 1020 shown in FIG. 8), by storing the limit value or values in association with an identifier of the document in the database.

In other embodiments, the storage is done in a new anti-copy mark supplied by the provider of anti-copy marks for the production of original documents. The anti-copy mark therefore has an encoding or an encryption of the limit value or values. In this embodiment, the anti-copy mark integrates, in a known way, an item of information representative of the limit value or values.

During a step 1170 the document is produced, generally in mass production. During a step 1175, for at least a part of the documents produced, the degradation of the anti-copy marks is measured, with the copy detection equipment installed on the printing equipment. During a step 1180, it is determined whether the measurement made during step 1175 is greater than the measurement taken during step 1155. If it is, during a step 1185, a warning signal is emitted, for example a digital signal intended for a production control computer, a sound signal and/or a light signal. If not, the method returns to step 1170. Depending on this signal, the printer can modify the inking and return to the limits authorized by the customer.

When the production run is finished, during a step 1190, if the anti-copy mark does not, itself, represent the limit value or values, an item of information, representative of the degradation measurement held in a database in association with an identifier of the document produced, is stored in the memory of mobile copy detection equipment.

When an item of mobile equipment is used, for example in a customs house, during a step 1195, the document is identified, either from information contained in the anti-copy mark or in a data carrier associated to this mark, for example a bar code, possibly two-dimensional, for example a datamatrix (registered trademark), or by inputting the visible information that is attached to it (model and manufacturer, for example).

During a step 1200, the copy detection equipment is utilized to measure a degradation of a mark on a document identified during step 1195. It is noted that steps 1195 and 1200 can form just one step, in particular when an identifier of the document is read by processing an image of the anti-copy mark.

During a step 1205, it is determined whether the measurement made during step 1200 is greater than the measurement stored during step 1190. If it is, during a step 1210 information concerning the mark analyzed or the product in question is transmitted remotely, so that the rights owner can act against potential counterfeiting of his/her product associated to the document. For example, this communication is carried out utilizing a mobile telephony network. Otherwise, at regular intervals of time, for example once a day, during a step 1215 information concerning the documents analyzed is transmitted remotely, so that the rights owner can trace his/her products.

At the end of either step 1210 or step 1215, the method returns to step 1195.

It is noted that steps 1160 and 1190 can be eliminated in the case in which the anti-copy mark represents, in the information it incorporates, the limit value or values that, for step 1175, represent the warning signal trigger threshold or thresholds and, for step 1205, represent the threshold or thresholds for distinguishing an original document from a copy.

In this way, the two extreme situations represented by the galley proof define the maximum error rate, or degradation measurement, authorized for ascertaining that a document is an original, within a tolerance margin.

It is noted that, during the production of original documents, the operator has, thanks to the utilization of certain aspects of this invention, two possible methods of technical assistance for setting the printing equipment:
the traditional densitrometric measurement for determining the print's quality or inking and/or
the measurement of the anti-copy mark's degradation made by an item of copy detection equipment associated to the print chain.

1-25. (canceled)

26. A method for making a so-called “original” document secure, that comprises:
a step of determining characteristics of an item of equipment printing said original document,
a step of determining a mark allowing an original to be distinguished from a copy, according to characteristics of said print equipment destined to be utilized for printing said mark on said document,
a step of printing said mark with said print equipment to form said original document and
a step of determining a first limit value to be used by an item of copy detection equipment to distinguish said original document from a copy of said original document, according to at least one print of said mark.

27. A method according to claim 26, that comprises a step of printing at least one print reference representative of an authorized maximum or minimum inking for printing said document and, during the step of determining the first limit value, a measurement is determined over at least one said print reference and a tolerance is added to it.

28. A method according to claim 26, that comprises a step of measuring a deterioration of the mark on a print chain, a step of comparing this measurement with a second pre-defined limit value and, if the second deterioration limit value is exceeded, a step of warning.

29. A method according to claim 26, that comprises:
a step of capturing an image representative of a digital authentication code,
a step of determining capture conditions for said image,
a step of determining an error rate for said digital authentication code represented by said captured image and
a step of determining an authenticity of the digital authentication code according to the error rate and the capture conditions for said image.

30. A method according to claim 29, wherein the step of determining capture conditions for said image comprises a step of determining a value representative of a quality of said image's capture.

31. A method according to claim 29, wherein the step of determining an image's capture conditions comprises a step of determining a value representative of a blurring of said image's capture.

32. A method according to claim 31, wherein, during the step of determining the authenticity, first of all it is determined whether the value representative of the blurring represents blurring below a pre-defined value and, if it is, whether the error rate is below a pre-defined value.

33. A method according to claim 32, wherein, if the value representative of blurring represents blurring above a pre-defined value, the steps of capturing an image, of determining the error rate and of determining authenticity are repeated.

34. A method according to claim 32, wherein, if the value representative of the blurring represents blurring below a pre-defined value, at least one part of said image is transmitted to a remote server and the step of determining authenticity is carried out by said remote server.

35. A method according to claim 31, wherein the step of determining a value representative of the blurring utilizes values representative of the digital authentication code's print conditions.

36. A method according to claim 29, that comprises:
a step of capturing an image representative of a test chart,
a step of determining an adjustment value from the image representative of the test chart and
a step of adjusting the error rate according to said adjustment value,
the step of determining the authenticity of the digital authentication code utilizing the adjusted error rate.

37. A method according to claim 29, wherein the step of determining an image's capture conditions comprises a step of determining a number of dots of said image that correspond to a digital authentication code.

38. A method according to claim 29, wherein, during the step of determining an image's capture conditions, a print sharpness of the digital authentication code is determined.

39. A method according to claim 26, that comprises:
a step of printing a digital authentication code carrier, utilizing print parameter values,
a step of capturing an image of the digital authentication code printed on said carrier,
a step of determining a print quality of the digital authentication code according to the image of the digital authentication code and
a step of printing at least one other carrier with print parameters according to said print quality.

40. A method according to claim 39, wherein, during the step of determining the print quality, the print quality is determined according to an information content of the digital authentication code read in said image.

41. A method according to claim 39, wherein, during the step of determining the print quality, an error rate is determined in the digital authentication code read in said image, the image quality being a function of said error rate.

42. A method according to claim 39, that comprises a step of determining if said image both allows a value borne by the printed digital authentication code to be read and presents an error rate less than a pre-defined limit value.
if this is not the case, a step of producing a new carrier and a repetition of the step of reading and the step of determining and
if this is the case, a step of printing digital authentication codes utilizing said carrier's print parameters.

43. A method according to claim 42, that comprises a step of determining said pre-defined limit value according to the value represented by the digital authentication code.

44. A method according to claim 39, that comprises:
a step of printing a plurality of digital authentication codes, utilizing print parameter values,
a step of capturing images of a plurality of printed digital authentication codes,
a step of determining the print quality for each one of a plurality of said images and
a step of storing a value representative of said print quality.

45. A method according to claim 26, that comprises a step of determining a signature of each captured image of a mark, and a step of printing an information matrix representing said signature on the document bearing the mark corresponding to said signature.
